(19) United States
(12) Patent Application Publication
(10) Pub. No.: US 2024/0208254 A1
(43) Pub. Date: Jun. 27, 2024

(54) FEED ASSEMBLY FOR A SUPPORT ASSEMBLY OF A HEAT TRANSFER PRINTER AND CUTTER

(71) Applicant: Stahls' Inc., St. Clair Shores, MI (US)

(72) Inventors: Benjamin B. Robinson, Smithfield, PA (US); Weiyu Zhang, Pittsburgh, PA (US); Hamza Oussous, Morgantown, WV (US)

(21) Appl. No.: 18/392,670

(22) Filed: Dec. 21, 2023

Related U.S. Application Data
(63) Continuation-in-part of application No. 18/085,669, filed on Dec. 21, 2022.

(51) Int. Cl. B41J 17/02; B41J 13/02

(52) U.S. Cl. CPC B41J 17/02; B41J 13/02

(57) ABSTRACT

A feed assembly for supporting feed material of a heat transfer printer and cutter and connectable to a support assembly of the heat transfer printer and cutter may include a first arm, a second arm, an adjustable roller, a passive roller, and a roller brake. The adjustable roller may extend between and may be rotatably connected to the first arm and the second arm. The passive roller may extend between and may be rotatably connected to the first arm and the second arm. The roller brake may be adjustably connected to the first arm and rotatably connected to the adjustable roller. Adjustable resistance may be appliable to the adjustable roller via the roller brake.

### CROSS-REFERENCE TO RELATED APPLICATIONS

This patent application is a continuation-in-part of and claims priority to U.S. patent application Ser. No. 18/085,669, filed on Dec. 21, 2022, the contents of which is hereby incorporated by reference in its entirety.

### TECHNICAL FIELD

The exemplary illustrations described herein are generally directed to feed assemblies for support assemblies, such as support assemblies for heat transfer printers and cutters.

### BACKGROUND

Lettering, logos, and designs applied to substrates such as fabrics and hard surfaces are often made as heat applied transfers. Heat transfer lettering and designs are often formed from a multi-layer feed material. One layer is generally a carrier, which may comprise a sheet of plastic material that is typically sticky or tacky. Another layer (e.g., a design layer) is comprised of the material used for the letters and designs themselves (i.e., a design material, such as vinyl), and is often formed on the carrier. The lettering, logo, and/or design may be cut out from the multi-layer material, such as by the heat transfer printer and cutter.

Known heat transfer printers and cutters are typically relatively large and heavy, and thus operators typically will mount the heat transfer printer and cutter on large tables, stands, or support assemblies. Even as heat transfer printers and cutters have become smaller and, in some cases, more portable, known support assemblies for heat transfer printers and cutters remain large, heavy, difficult to adjust and/or move, and challenging to store. Moreover, some support assemblies may only be compatible with a single heat transfer printer and cutter or a small number of heat transfer printers and cutters.

Accordingly, there is a need for an improved support assembly for heat transfer printers and cutters.

### SUMMARY

A feed assembly for supporting feed material of a heat transfer printer and cutter and connectable to a support assembly of the heat transfer printer and cutter may include a first arm, a second arm, an adjustable roller, a passive roller, and a roller brake. The adjustable roller may extend between and may be rotatably connected to the first arm and the second arm. The passive roller may extend between and may be rotatably connected to the first arm and the second arm. The roller brake may be adjustably connected to the first arm and rotatably connected to the adjustable roller. Adjustable resistance may be appliable to the adjustable roller via the roller brake.

A method of connecting a feed assembly for supporting feed material of a heat transfer printer and cutter to a support assembly of the heat transfer printer and cutter may include providing a first arm, a second arm, a first bracket, a second bracket, an adjustable roller, a passive roller, and a roller brake. The method may further include slidably and pivotably connecting the first arm and the first bracket, and establishing a snap-fit connection between the first arm and the first bracket via pivoting the first arm relative to the first bracket. The method may also include slidably and pivotably connecting the second arm and the second bracket, and establishing a snap-fit connection between the second arm and the second bracket via pivoting the second arm relative to the second bracket. In addition, the method may include adjustably connecting the roller brake to the first arm, rotatably connecting the adjustable roller to the first arm and to the second arm, and rotatably connecting the passive roller to the first arm and to the second arm.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the disclosed subject matter described herein is not intended to be exhaustive or otherwise limiting or restricting to the precise form and configuration shown in the drawings and disclosed in the following detailed description. Examples of the present disclosed subject matter are described in detail by referring to the drawings as follows.

FIG. 1 is a perspective view of an exemplary support assembly;

FIG. 2 is a close-up, perspective view of a cross member of the support assembly shown in FIG. 1, with the cross member shown in phantom to illustrate an exemplary lock mechanism;

FIG. 3 is a partial cutaway perspective view of the cross member of the support assembly shown in FIG. 1;

FIGS. 4A through 4E illustrate an exemplary method of adjusting the support assembly of FIG. 1 from a storage position to a use position;

FIGS. 5A through 5C illustrate an exemplary method of connecting a first and second support member of the support assembly of FIG. 1;

FIG. 6 is a perspective view of the support assembly shown in FIG. 1, with an exemplary feed assembly connected to the support members, an exemplary heat transfer printer and cutter (shown in phantom) disposed on and connected to the support assembly, and a roll of feed material (shown in phantom) disposed on the feed assembly;

FIG. 7 is a perspective, partially exploded view of the support assembly of FIG. 6; and

FIGS. 8A and 8B are close-up, perspective views of portions of the feed material assembly of the support assembly of FIG. 6;

FIG. 9 is a perspective, partial view of an exemplary support assembly with an exemplary feed assembly;

FIGS. 10A and 10B are a perspective, partially exploded views of the feed assembly and support assembly of FIG. 9;

FIG. 11 is a perspective, partial view of a first bracket of the feed assembly of FIG. 9 with the bracket cover removed;

FIG. 12A is a perspective, partial view of a first arm of the feed assembly of FIG. 9;

FIG. 12B is a perspective, exploded view of the first arm of FIG. 12A;

FIGS. 13A and 13B are close-up, perspective views of portions of the feed assembly of the support assembly of FIG. 9; and

FIGS. 14A through 14H illustrate an exemplary method of assembling the feed assembly of FIG. 9 and/or connecting the feed assembly and the support assembly of FIG. 9.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

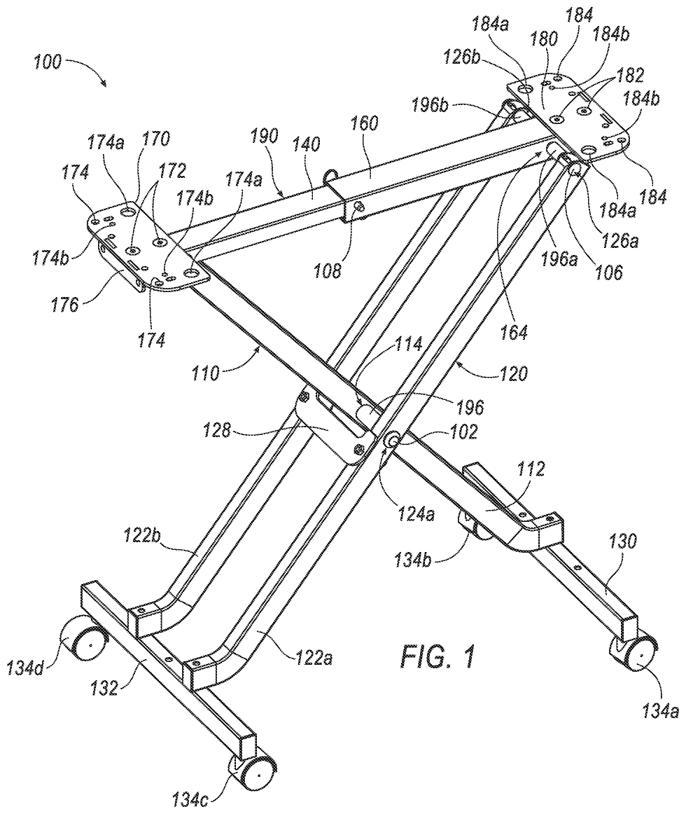

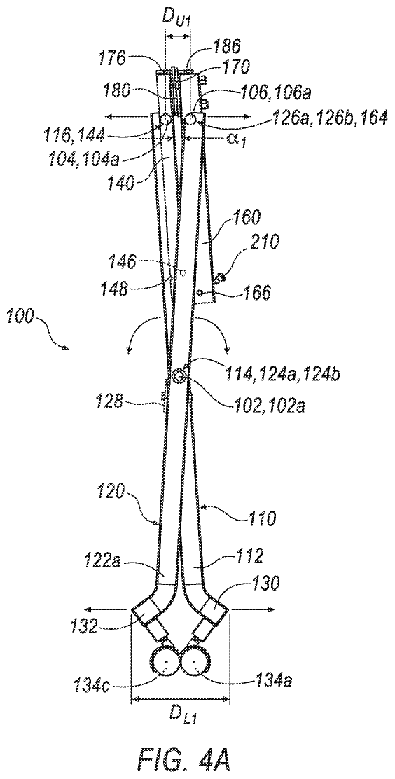

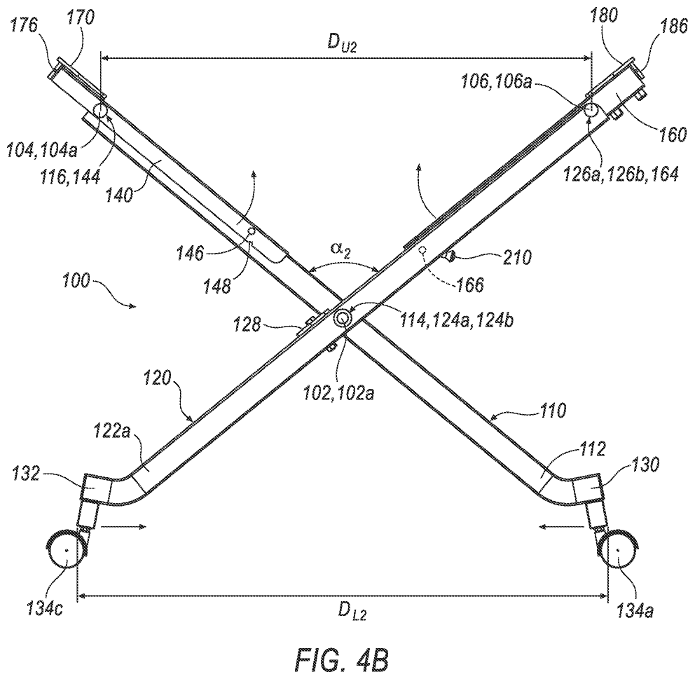

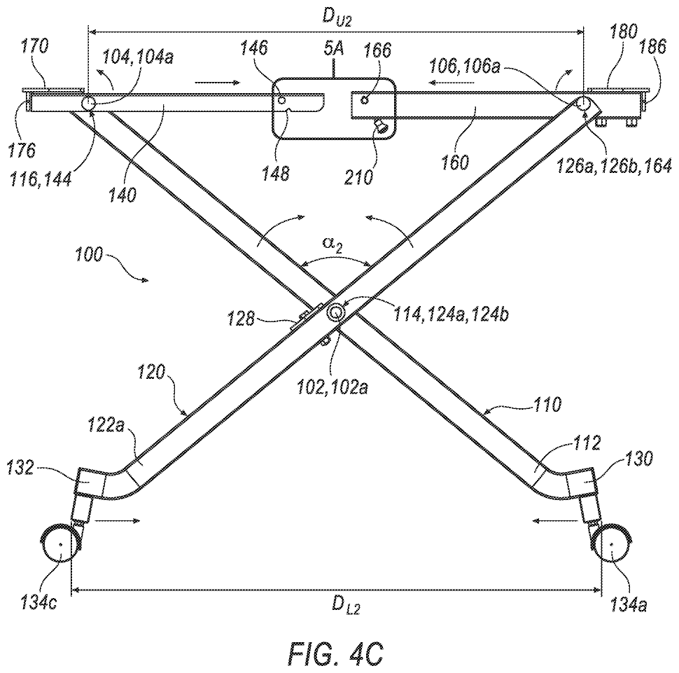

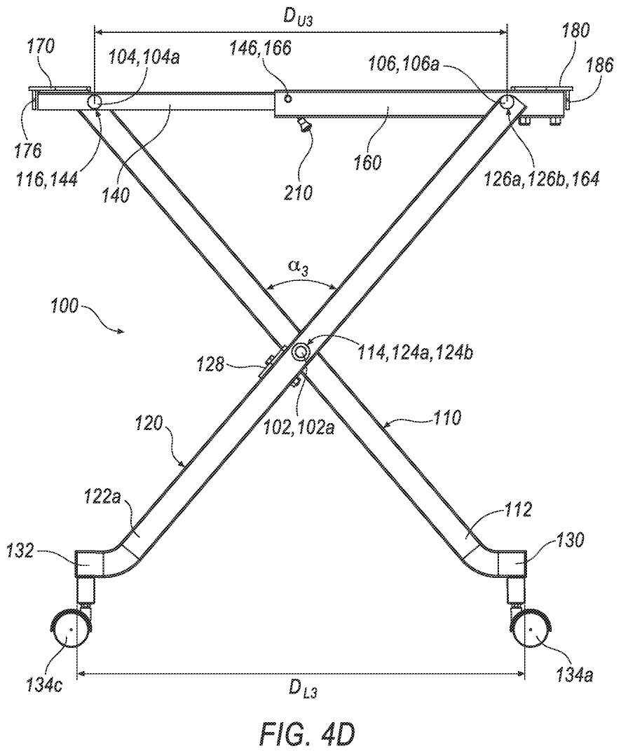

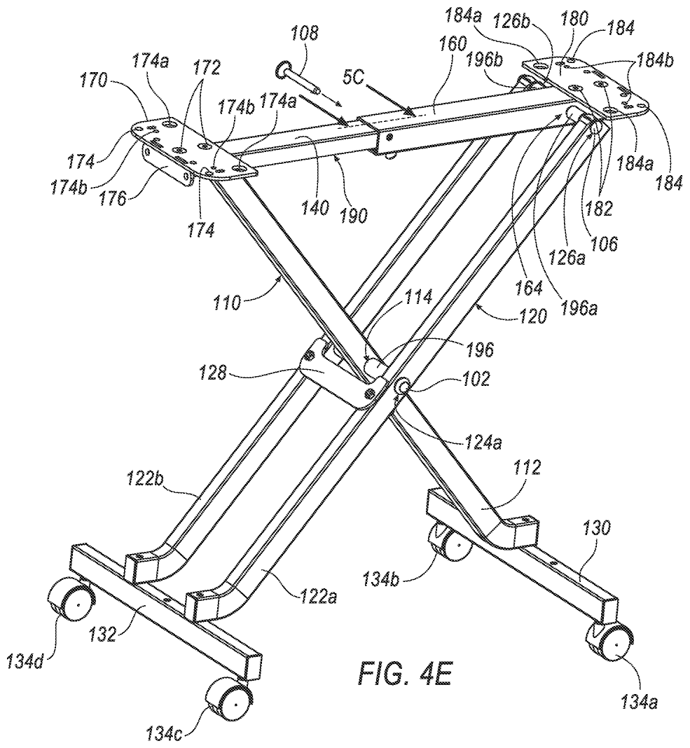

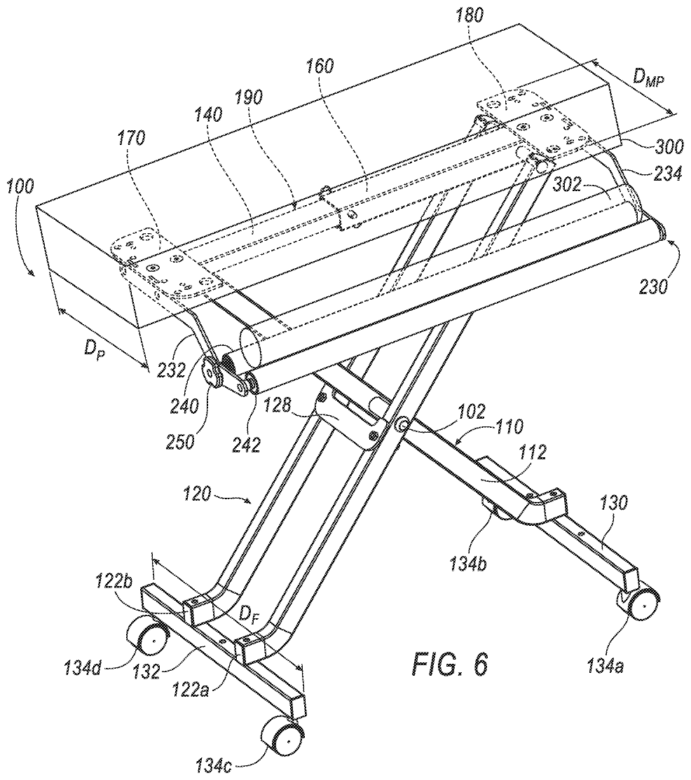

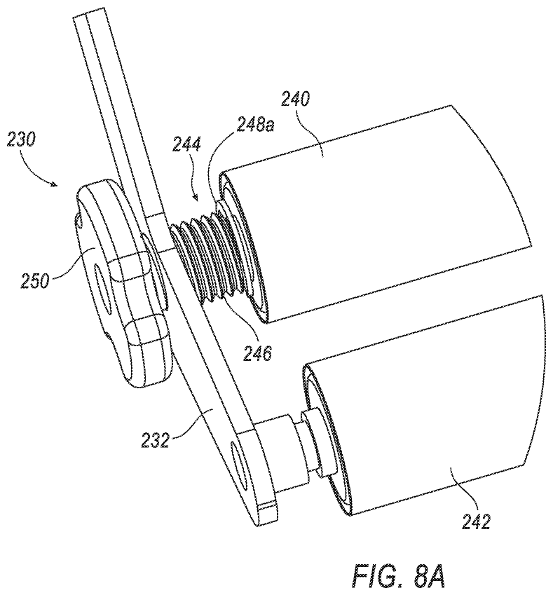

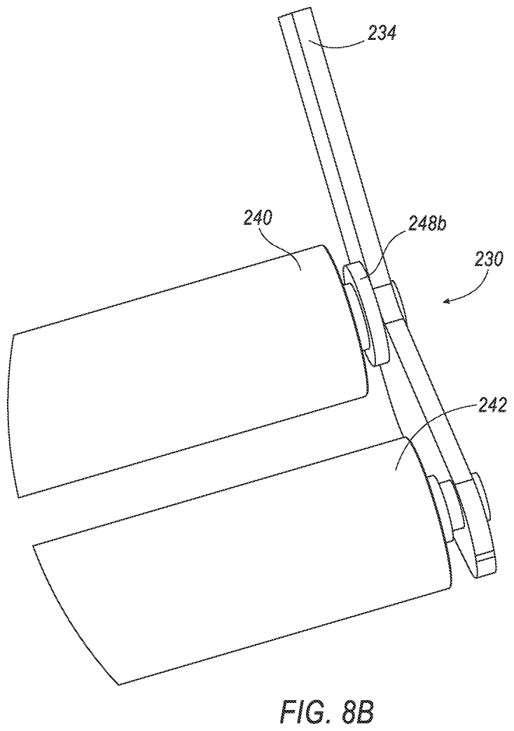

Referring now to FIGS. 1-8B, an exemplary support assembly 100 for a heat transfer printer and cutter 300 is shown. Optionally, the support assembly 100 may include a feed assembly 230 for supporting and/or retaining feed material 302 (e.g., a roll of feed material, such as a roll of multi-layer material that may include vinyl) as illustrated in FIGS. 6-8B. The support assembly 100 is adjustable to a storage position and a use position. When the support assembly 100 is disposed in the storage position (see FIG. 4A), the support assembly 100 is more compact enabling it to be easily moved (e.g., around a shop floor) and stored. When the support assembly 100 is disposed in the use position (see FIGS. 1-3, 4D, 4E, 5C, 6, and 7), a heat transfer printer and cutter 300 is connectable to the support assembly 100 and the support assembly 100 is able to support the weight of the heat transfer printer and cutter 300 and the feed material 302 in a secure and stable manner. The support assembly 100 may be selectively locked in the use position by a safety pin 108 to prevent the support assembly 100 from being adjusted out of the use position (e.g., toward and/or to the storage position), which may reduce risk of injury and/or property damage. The safety pin 108 may also function as a second safety feature (in addition to the lock mechanism 200). Optionally, a size and/or a material of the safety pin 108 is selected to satisfy one or more stress and/or fatigue thresholds or standards. Therefore, the safety pin 108 size and material are selected to meet desired stress and fatigue thresholds, and works as a second safety feature in addition to the lock mechanism 200.

Referring now to FIG. 1, the support assembly 100 includes a first leg 110, a second leg 120, a first support member 140, and a second support member 160. The first leg 110 and the second leg 120 extend in substantially parallel planes and are pivotably connected to one another via a leg pin 102, which defines a first pivot axis 102a. The first support member 140 is pivotably connected to the first leg 110 via a first support pin 104, which defines a second pivot axis 104a. The second support member 160 is pivotably connected to the second leg 120 via a second support pin 106, which defines a third pivot axis 106a. The first support member 140 and the second support member 160 are releasably connectable by a lock mechanism 200 and/or a safety pin 108 to form a cross member 190, which connects the first leg 110 and the second leg 120 to one another. The cross member 190 restricts and/or effectively prevents rotation of the first leg 110 and the second leg 120 about the leg pin 102, rotation of the first leg 110 and the first support member 140 about the first support pin 104, and rotation of the second leg 120 and the second support member 160 about the second support pin 106. The leg pin 102, the support pins 104, 106, and the safety pin 108 extend substantially parallel to one another. The first, second, and third pivot axes 102a, 104a, 106a extend substantially parallel to one another and to the safety pin 108.

The first leg 110 includes a first leg member 112, a leg pin recess 114, a support pin recess 116, a first foot 130, and a plurality of first wheels 134a, 134b. The first leg 110 has an upper end, a lower end, and an intermediate region disposed therebetween.

The first leg member 112 is structured as an elongated member, such as a hollow tube or solid bar. The first leg member 112 has a first longitudinal end (e.g., an upper end), a second longitudinal end (e.g., a lower end), and an intermediate region disposed therebetween. The intermediate region of the first leg 110 and/or the first leg member 112 is pivotably connected to the second leg 120 via the leg pin 102. The upper end of the first leg 110 and/or the first leg member 112 is pivotably connected to the first support member 140 via the first support pin 104. The lower end of the first leg member 112 is connected (e.g., fixed) to the first foot 130.

The first leg member 112 includes the leg pin recess 114 and the support pin recess 116. The leg pin recess 114 is disposed in the intermediate region of the first leg 110 and/or the first leg member 112 and receives the leg pin 102. The support pin recess 116 is disposed adjacent to the upper end of the first leg 110 and/or the first leg member 112 and receives the first support pin 104.

The second leg 120 includes a second leg member 122a, a third leg member 122b, a plurality of leg pin recesses 124a, 124b, a plurality of support pin recesses 126a, 126b, a stop 128, a second foot 132, and a plurality of second wheels 162a, 162b. The second leg 120 has a first longitudinal end (e.g., an upper end), a second longitudinal end (e.g., a lower end), and an intermediate region disposed therebetween. In other embodiments, the second leg 120 only includes a single leg member and/or the first leg 110 includes the stop 128.

The second leg member 122a is structured as an elongated member, such as a hollow tube or solid bar. The second leg member 122a has a first longitudinal end (e.g., an upper end), a second longitudinal end (e.g., a lower end), and an intermediate region disposed therebetween. The intermediate region of the second leg 120 and/or the second leg member 122a is pivotably connected to the first leg 110 via the leg pin 102. The upper end of the second leg 120 and/or the second leg member 122a is pivotably connected to the second support member 160 via the second support pin 106. The lower end of the second leg member 122a is connected (e.g., fixed) to the second foot 132.

The second leg member 122a includes a leg pin recess 124a and a support pin recess 126a. The leg pin recess 124a is disposed in the intermediate region of the second leg 120 and/or the second leg member 122a and receives the leg pin 102. The support pin recess 126a is disposed adjacent to the upper end of the second leg 120 and/or the second leg member 122a and receives the second support pin 106.

The third leg member 122b includes a leg pin recess 124b and a support pin recess 126b. The third leg member 122b, leg pin recess 124b, and support pin recess 126b are structured and arranged like the second leg member 122a, leg pin recess 124a, and support pin recess 126a and, for brevity, are not described in detail. The third leg member 122b extends substantially parallel to the second leg member 122a and is disposed spaced apart from the second leg member 122a. The second and third leg members 122a, 122b are connected (e.g., fixed) to one another via the second foot 132 and the stop 128.

The first, second, and third leg members 112, 122a, 122b extend in substantially parallel planes. The first leg member 112 is disposed between the second and third leg members 122a, 122b such that the leg pin recesses 114, 124a, 124b are aligned with one another. The leg pin 102 is disposed in and extends through the leg pin recesses 114, 124a, 124b transversely (e.g., perpendicularly) to the first, second, and third leg members 112, 122a, 122b thereby pivotably connecting the first leg 110 and the second leg 120. The stop 128 extends between and connects the second leg member 122a and the third leg member 122b adjacent to the leg pin recesses 124a, 124b and/or the leg pin 102. The stop 128 restricts and/or prevents rotation of the legs 110, 120 about the leg pin 102 beyond a certain point (e.g., beyond the stopped position shown in FIGS. 4B and 4C) by contacting the first leg member 112, to prevent the assembly from falling down and upon itself during assembly.

The first foot 130 and the second foot 132 are each structured as an elongated member, such as a hollow tube or solid bar. The feet 130, 132 extend substantially transversely (e.g., perpendicularly) to the legs 110, 120, the leg members 112, 122a, 122b, and the support members 140, 160. The feet 130, 132 may also extend substantially parallel to the pins 102, 104, 106, 108. The first foot 130 is disposed at the lower end of the first leg 110 and is connected (e.g., fixed) to the lower end of the first support member 112. The second foot 132 is disposed at the lower end of the second leg 120 and is connected (e.g., fixed) to the lower end of the second and third leg members 122a, 122b. The first wheels 134a, 134b are connected to the first foot 130 and are disposed at opposite longitudinal ends of the first foot 130. The second wheels 134c, 134d are connected to the second foot 132 and are disposed at opposite longitudinal ends of the second foot 132. However, the wheels 134a-134d may be disposed on the first foot 130 and/or the second foot 132 at other suitable positions as desired. The wheels 134a-134d may be selectively lockable to restrict and/or prevent movement of the support assembly 100, such as when in the use position. As generally illustrated in FIG. 6, a length D_{F} of the feet 130, 132 may be greater than a length D_{MP} of the mounting plates 170, 180 and/or a length D_{P} of most heat transfer printers and cutters 300, which may increase the stability of the support assembly 100 and/or reduce the likelihood of the support assembly 100 tipping over, particularly when the wheels 134a-134d are locked.

The first support member 140 is structured as an elongated member having a generally U-shaped cross-sectional profile and defines a channel 142. The first support member 140 has a first longitudinal end and a second longitudinal end (e.g., a free end). The first end of the first support member 140 is pivotably connected to the upper end of the first leg 110 and/or the first leg member 112 via the first support pin 104. The second/free end of the first support member 140 is insertable into the internal space 162 of the second support member 160 and is releasably connectable to the second support member 160 by the lock mechanism 200 and/or the safety pin 108 form the cross member 190.

The first support member 140 includes a support pin recess 144, a safety pin recess 146, and a notch 148. The support pin recess 144 is disposed adjacent to the first end of the first support member 140 and receives the first support pin 104. The safety pin recess 146 is disposed adjacent to the second/free end of the first support member 140 and receives the safety pin 108. The notch 148 is configured to selectively receive a portion of the lock mechanism 200 (e.g., the second plate 204). The notch 148 is disposed adjacent to the second/free end of the first support member 140 and/or the safety pin recess 146. The notch 148 and the first mounting plate 170 are disposed on opposite sides of the first support member 140. The notch 148 is generally triangular and/or wedge shaped, and opens in the same direction as the channel 142 (e.g., generally vertically downward toward the ground and/or the feet 130, 132 when the support assembly 100 is disposed in the use position).

A portion of the upper end of the first leg 110 and/or the first leg member 112 is disposed within the channel 142 of the first support member 140 such that the support pin recess 116 of the first leg 110 is disposed in the channel 142 and aligned with the support pin recess 144 of the first support member 140. The first support pin 104 is disposed in and extends through the support pin recesses 116, 146 transversely (e.g., perpendicularly) to the first leg 110, the first leg member 112, and the first support member 140 thereby pivotably connecting the first leg 110 and the first support member 140.

The second support member 160 is structured as a hollow elongated member defining an internal space 162 into which the first support member 140 is insertable. The second support member 160 has a first longitudinal end and a second longitudinal end (e.g., a free/open end). The first end of the second support member 160 is pivotably connected to upper end of the second leg 120 and/or the second and third leg members 122a, 122b via the second support pin 106. The second/free end of the second support member 160 is open such that the first support member 140 is insertable into the internal space 162 through the second/free end. The second end of the second support member 160 is releasably connectable to the first support member 140 by the lock mechanism 200 and/or the safety pin 108 to form the cross member 190.

The second support member 160 includes a support pin recess 164, a safety pin recess 166, a shaft slot 168, and the lock mechanism 200. The support pin recess 164 is disposed adjacent to the first end of the second support member 160 and receives the second support pin 106. The safety pin recess 166 is disposed adjacent to the free/open end of the second support member 160 and receives the safety pin 108. The shaft slot 168 receives a portion of the lock mechanism 200 (e.g., the shaft 212) and is disposed adjacent to the free/open end of the second support member 160, the safety pin recess 166, and/or the lock mechanism 200.

The first end of the second support member 160 is disposed between and spaced apart from the upper ends of the second and third leg members 122a, 122b such that the support pin recesses 126a, 126b, 164 are aligned with one another. The second support pin 106 is disposed in and extends through the support pin recesses 126a, 126b, 164 transversely (e.g., perpendicularly) to the second leg 120, the second and third leg members 122a, 122b, and the second support member 160 thereby pivotably connecting the second leg 120 and the second support member 160.

The support assembly 100 and/or the first support member 140 includes a first mounting plate 170. The first mounting plate 170 is disposed on an upper surface of the first support member 140 adjacent to the first end of the first support member 140 and connected thereto via plate screws 172. The support pin recess 144 and/or the first support pin 104 are disposed between the first mounting plate 170 and the free end of the first support member 140 and/or the safety pin recess 146. The first mounting plate 170 includes a plurality of mounting openings 174 for connecting one or more different types of heat transfer printers and cutters and/or adapter plates to the support assembly 100. Optionally, the first mounting plate 170 may include a first plate projection 176 for connecting the feed assembly 230 to the support assembly 100. The first plate projection 176 projects transversely (e.g., perpendicularly) to the mounting plate 170 adjacent to the first end of the first support member 140.

The support assembly 100 and/or the second support member 160 includes a second mounting plate 180. The second mounting plate 180 is disposed on an upper surface of the second support member 160 adjacent to the first end of the first support member 140 and connected thereto via plate screws 182. The support pin recess 164 and/or the second support pin 106 are disposed between the second mounting plate 180 and the open end of the second support member 160 and/or the safety pin recess 166. The second mounting plate 180 includes a plurality of mounting openings 184 and, optionally, a second plate projection 186. The mounting openings 184 and the second plate projection 186 are structured and arranged like the mounting openings 174 and the first plate projection 176 and, for brevity, are not described in detail. By arranging the mounting plates 170, 180 on top of the support members 140, 160 and outside of the support pins 104, 106, the heat transfer printer and cutter 300 does not directly contact and/or rest on the support members 140, 160 and the weight of the heat transfer printer and cutter 300 is not applied directly onto the lock mechanism 200 and/or the safety pin 108, which may extend the operational life of the lock mechanism 200 and/or the safety pin 108.

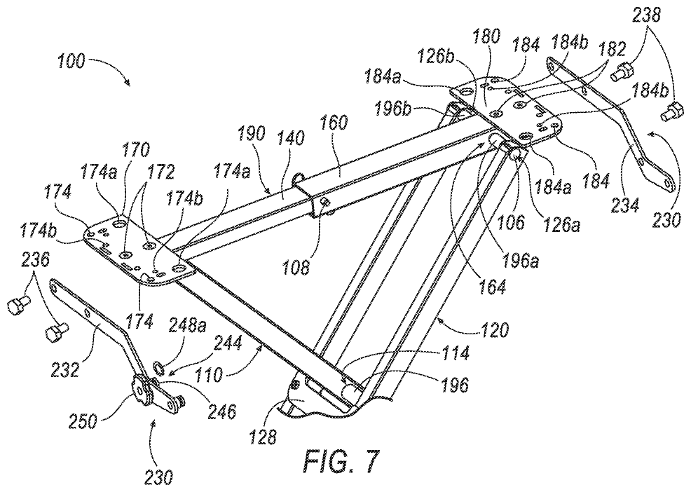

When the support assembly 100 is disposed in the use position, the mounting openings 174, 184 define a plurality of opening patterns that each correspond to a different mounting pattern commonly utilized to mount heat transfer printers and cutters as generally shown in FIGS. 1 and 7. For example, a first subset of the mounting openings 174a, 184a define a first opening pattern and, thus, enable any heat transfer printer and cutter (e.g., a first heat transfer printer and cutter) with the corresponding first mounting pattern to be mounted on the support assembly 100. A second subset of the mounting openings 174b, 184b define a second opening pattern and, thus, enable any heat transfer printer and cutter (e.g., a second heat transfer printer and cutter) with the corresponding second mounting pattern to be mounted on the support assembly 100. To mount a heat transfer printer and cutter with a mounting pattern that does not correspond to any of the opening patterns defined by the mounting openings 174, 184, one or more adapter plates with openings that define the corresponding opening pattern may be connected to the mounting plates 170, 180 via the mounting openings 174, 184. Additionally and/or alternatively, the mounting plates 170, 180 may be removed and replaced with different mounting plates with openings that define the corresponding opening pattern.

One or more spacers 196 is arranged on one or more of the pins 102, 104, 106. The spacers 196 may properly position the leg members 112, 122a, 122b and/or the support members 140, 160 on the associated pin 102, 104, 106 and/or may restrict the leg members 112, 122a, 122b and/or the support members 140, 160 from moving axially along the associated pin 102, 104, 106 (e.g., relative to one another). In this manner, the spacers 196 maintain alignment of the leg members 112, 122a, 122b and/or the support members 140, 160 relative to one another and, thus, make it easier for a user to adjust the support assembly 100 between the storage position and the use position. For example, as can be seen in FIG. 1, a first spacer 196a is arranged on the second support pin 106 between the second support member 160 and the second leg member 122a substantially filling the gap therebetween. A second spacer 196b is arranged on the second support pin 106 between the second support member 160 and the third leg member 122b substantially filling the gap therebetween. The spacers 196a, 196b properly align and position the second support member 160 relative to the leg members 122a, 122b and the first support member 140, which makes it easier to insert the first support member 140 into the second support member 162 when adjusting the support assembly 100 to the use position.

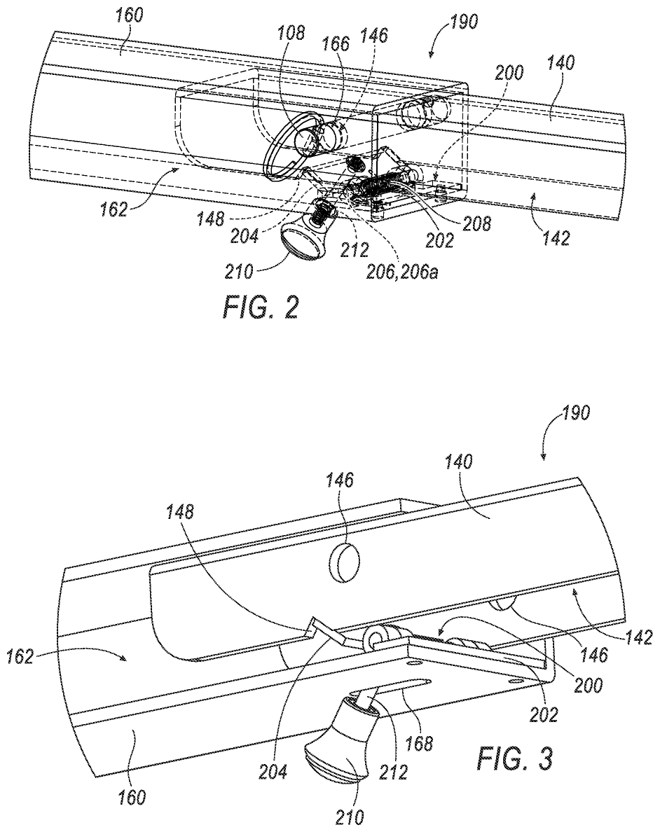

Referring now to FIGS. 2 and 3, the second support member 160 includes the lock mechanism 200, which is structured as a spring-loaded hinge lock. The lock mechanism 200 is disposed partially within the internal space 162 at and/or adjacent to the free/open end of the second support member 160. The lock mechanism 200 includes a first plate 202, a second plate 204, a hinge pin 206, a hinge spring 208, a release knob 210, and a shaft 212. The first plate 202 is disposed on and connected (e.g., fixed) to the second support member 160. The second plate 204 is pivotably connected to the first plate 202 via the hinge pin 206 and selectively engages the notch 148 to releasably connect the first and second support members 140, 160. The hinge pin 206 extends substantially parallel to the pins 102, 104, 106, 108 and defines a fourth pivot axis 206a. The hinge spring 208 biases the second plate 204 toward the first plate 202 and/or away from the shaft slot 168. The release knob 210 is disposed outside of the internal space 162 and is connected to the second plate 204 via the shaft 212. The shaft 212 is disposed in and extends through the shaft slot 168 of the second support member 160 such that the shaft 212 is adjustable and/or movable within the shaft slot 168. The shaft 212 is thus disposed partially inside and partially outside the internal space 162. The second plate 204, the release knob 210, and the shaft 212 rotate about the hinge pin 206 in conjunction with one another. As such, a user may actuate, move, and/or adjust the release knob 212 to change, move, and/or adjust the position of the second plate 204 relative to the first support plate 202 (e.g., to disengage the second plate 204 from the notch 148). When the second plate 204 is engaged with the notch 148, the support members 140, 160 are connected to form the cross member 190 and the safety pin recesses 146, 166 are aligned with one another such that the safety pin 108 is insertable into the safety pin recesses 146, 166. When the safety pin 108 is disposed in the safety pin recesses 146, 166 the support members 140, 160 are restricted and/or prevented from disconnecting (e.g., in the event that the lock mechanism 200 becomes disengaged from the notch 148).

Referring now to FIG. 4A, the support assembly 100 disposed in the storage position, in which the support assembly 100 is more compact enabling it to be easily moved (e.g., around a shop floor) and stored. When the support assembly 100 is disposed in the storage position, the legs 110, 120 are disposed in a first/folded position and the support members 140, 160 are not connected to one another via the lock mechanism 200 and are disposed in a first/collapsed position. When the legs 110, 120 are disposed in the folded position (see FIG. 4A), a first angle α₁ is defined between the first leg 110 and the second leg 120, the support pins 104, 106 are disposed spaced apart from one another by a first upper distance D_{U1}, the feet 130, 132 are disposed spaced apart from one another by a first lower distance D_{L1}, and the mounting plates 170, 180 extend substantially vertical and contact one another. When the support members 140, 160 are disposed in the collapsed position (see FIGS. 4A and 4B), the first support member 140 extends substantially parallel to the first leg 110 and/or the first leg member 112 and the second support member 160 extends substantially parallel to the second leg 120 and/or the leg members 122a, 122b. The second/free end of the first support member 140 is arranged on the first leg 110 and/or the first leg member 112 such that the first leg member 112 is partially disposed within the channel 144 and extends substantially parallel to the first support member 140 therein. In other words, the first leg member 112 is at least partially nested within the first support member 140. The free/open end of the second support member 160, the safety pin recess 166, and/or the lock mechanism 200 are disposed at least partially between the second and third leg members 122a, 122b of the second leg 120.

Referring now to FIGS. 1-3, 4D, 4E, 5C, 6, and 7, the support assembly 100 disposed in the use position, in which a heat transfer printer and cutter 300 is connectable to the support assembly 100 and the support assembly 100 is able to support the weight of the heat transfer printer and cutter 300 and the feed material 302 in a secure and stable manner. When the support assembly 100 is disposed in the use position, the first leg 110 and/or the first leg member 112 are disposed spaced apart from (i.e., does not directly contact) the stop 128 and the support members 140, 160 are disposed in an engaged position in which the support members 140, 160 are connected to one another via the lock mechanism 200 to form the cross member 190. A third angle α₃ is defined between the legs 110, 120, the support pins 104, 106 are disposed spaced apart from one another by a third upper distance D_{U3}, and the feet 130, 132 are disposed spaced apart from one another by a third lower distance D_{L3}. The support members 140, 160 are disposed substantially parallel to one another and/or to the ground/floor. The first support member 140 extends obliquely relative to the first leg 110 and/or the first leg member 112. The second support member 160 extends obliquely relative to the second leg 120 and/or the second and third leg members 122a, 122b. The first support member 140 projects into the internal space 162 of the second support member 160 through the free/open end of the second support member 160 and is disposed at least partially in the second support member 160. The second plate 204 is disposed partially in the notch 148 and contacts the first support member 140 (i.e., the lock mechanism 200 is engaged with the first support member 140) connecting the support members 140, 160. The safety pin recesses 146, 166 are aligned with one another such that the safety pin 108 is insertable into the safety pin recesses 146, 166. The mounting plates 170, 180 extend substantially parallel to one another and are disposed spaced apart from one another in a common horizontal plane such that the mounting openings 174, 184 define the plurality of opening patterns.

FIGS. 4A-4E illustrate an exemplary method of adjusting the support assembly 100 from the storage position (see FIG. 4A) to the use position (see FIGS. 1-3, 4D, 4E, 5C, 6, and 7) and locking the support assembly 100 in the use position with the safety pin 108. The support assembly 100 is adjustable to the storage position and to the use position by rotating the first leg 110 and the second leg 120 relative to one another about the leg pin 102, rotating the first support member 140 relative to the first leg 110 about the first support pin 104, and rotating the second support member 160 relative to the second leg 120 about the second support pin 106.

As generally illustrated by the movement arrows in in FIG. 4A, the method includes adjusting the legs 110, 120 from the folded position shown in FIG. 4A to a stopped position shown in FIG. 4B via rotating the legs 110, 120 away from one another about the leg pin 102 until the first leg 110 and/or the first leg member 112 contacts the stop 128 and further rotation of the legs 110, 120 is prevented. The rotation of the legs 110, 120 to the stopped position (i) increases an angle defined between the legs 110, 120 from the first angle α₁ to a second angle α₂, (ii) moves the upper end of the first leg 110 (as well as the first support pin 104, the first mounting plate 170, etc.) and the upper end of the second leg 120 (as well as the second support pin 106, the second mounting plate 180, etc.) away from one another increasing a distance between the support pins 104, 106 from the first upper distance D_{U1} to a second upper distance D_{U2}, and (iii) moves the lower end of the first leg 110 (as well as the first foot 130) and the lower end of the second leg 120 (as well as the second foot 132) away from one another increasing a distance between the feet 130, 132 from the first lower distance D_{L1} to a second lower distance D_{L2}. When the legs 110, 120 are in the stopped position, the support members 140, 160 are rotatable about the support pins 104, 106 without coming into contact with one another. This enables the support members 140, 160 to each be adjusted to one or more desired positions and prevents the support members 140, 160 from blocking one another from being adjusted (e.g., to the insertion position). Additionally, since further rotation of the legs 110, 120 is prevented, the legs 110, 120 are maintained in the stopped position by the stop 128 and the support assembly 100 is able to stand freely on its own. This enables the user adjusting the support assembly 100 to release the legs 110, 120 and use both hands during one or more subsequent steps (e.g., when rotating the support members 140, 160 about the support pins 104, 106), which may make these steps significantly easier to perform. Adjusting the legs 110, 120 to the stopped position is not required, however. For example, the legs 110, 120 may be rotated about the leg pin 102 to a position just short of and/or close to the stopped position in which there is sufficient clearance between the support pins 104, 106 to adjust the support members 140, 160 from the collapsed position to the insertion position as described below.

As generally illustrated by the movement arrows in in FIG. 4B, the method includes adjusting the support members 140, 160 from the collapsed position shown in FIG. 4B to an insertion position shown in FIG. 4C when the legs 110, 120 are in the stopped position. Adjusting the support members 140, 160 to the insertion position includes rotating the first support member 140 about the first support pin 104 away from the first leg 110 and rotating the second support member 160 about the second support pin 106 away from the second leg 120 until the support members 140, 160 are substantially aligned with one another to facilitate insertion of the first support member 140 into the internal space 162 of the second support member 160. When the support members 140, 160 are substantially aligned with one another (i.e., are in the insertion position), the free end of the first support member 140 is disposed spaced apart from and faces the free/open end of the second support member 160. Additionally, the support members 140, 160 are disposed substantially parallel to one another and/or to the ground.

The support members 140, 160 may also be adjusted from the collapsed position to the insertion position when the legs 110, 120 are not disposed in the stopped position. For example, the support member 140, 160 may be adjusted from the collapsed position to the insertion position in any position of the legs 110, 120 where there is sufficient clearance between the support pins 104, 106 to do so. This may be more challenging, however, because a user would have to hold the legs 110, 120 to maintain their position (e.g., prevent them from rotating about the leg pin 102) while simultaneously adjusting the support member 140, 160 to the insertion position.

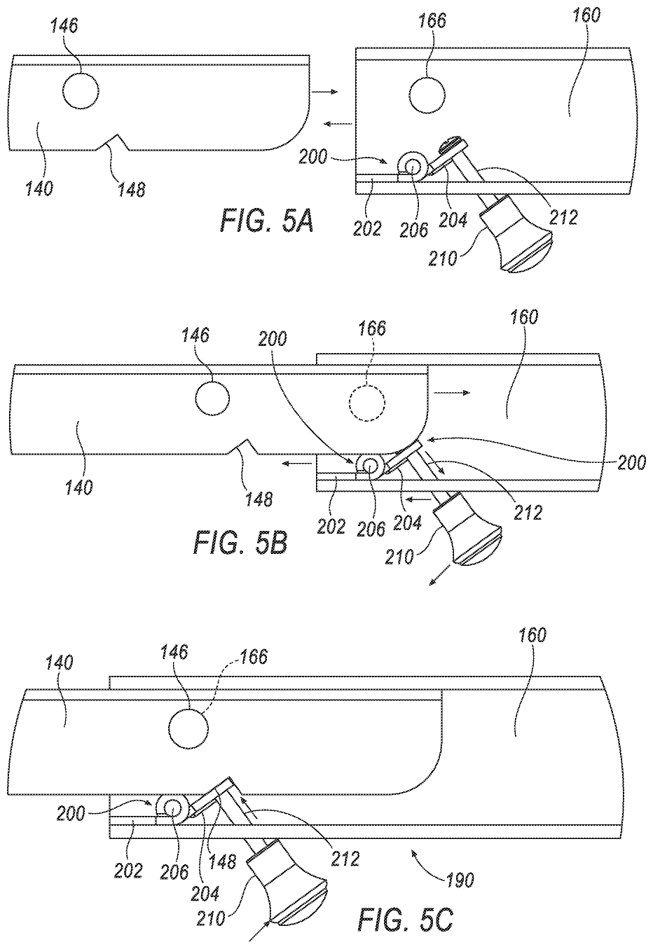

As generally illustrated by the movement arrows in in FIG. 4C, the method includes adjusting the support members 140, 160 from the insertion position shown in FIG. 4C to an engaged position shown in FIGS. 4D and 4E to connect the support members 140, 160, form the cross member 190, and place the support assembly 100 in the use position. To adjust the support members 140, 160 to the engaged position, the legs 110, 120 are rotated toward one another about the leg pin 102 to move the upper end of the first leg 110 (as well as the first support pin 104, the first support member 140, etc.) and the upper end of the second leg 120 (as well as the second support pin 106, the second support member 160, etc.) toward one another. While rotating the legs 110, 120 about the leg pin 102, the first support member 140 is rotated away from the first leg 110 about the first support pin 104 and the second support member 160 is rotated away from the second leg 120 about the second support pin 106 to maintain alignment of the support members 140, 160 and facilitate insertion of the first support member 140 into the internal space 162 of the second support member 160. By rotating the legs 110, 120 while simultaneously rotating the support members 140, 160, the free end of the first support member 140 is inserted into the internal space 162 through the free/open end of the second support member 160, and the notch 148 and the lock mechanism 200 are moved toward one another until the lock mechanism 200 (e.g., the second locking plate 204) engages the notch 148 and prevents further rotation of the legs 110, 120 about the leg pin 102. Engaging the lock mechanism 200 and the notch 148, the process of which is illustrated in FIGS. 5A-5C and described in detail below, releasably connects the support members 140, 160 to form the cross member 190. The rotation of the legs 110, 120 also (i) reduces the angle defined between the legs 110, 120 from the second angle α₂ to the third angle α₃, which is greater than the first angle α₁, (ii) decreases the distance between the support pins 104, 106 from the second upper distance D_{U2} to a third upper distance D_{U3}, which is greater than the first upper distance D_{U1}, and (iii) decreases the distance between the feet 130, 132 from the second lower distance D_{L2} to the third lower distance D_{L3}, which is greater than the first lower distance D_{L1}.

As generally illustrated by the movement arrows in FIG. 4E, the method includes selectively locking the support assembly 100 in the use position via engaging the safety pin 108 and the cross member 190. Engaging the safety pin 108 and the cross member 190 includes inserting the safety pin 108 into the safety pin recesses 146, 166.

FIGS. 5A-5C show cross-sectional views through the lock mechanism 200 illustrating the process of engaging the lock mechanism 200 and the notch 148 when adjusting the support members 140, 160 from the insertion position shown in FIG. 4C to the engaged position shown in FIGS. 4D and 4E. As explained above, the legs 110, 120 and support members 140, 160 are rotated to move the first support member 140 and the second support member 160 toward one another while maintaining their relative alignment as illustrated in FIG. 5A. The free end of the first support member 140 is inserted into the internal space 162 through the free/open end of the second support member 160. As illustrated in FIG. 5B, a curved contact/pressing surface of the first support member 140 contacts and pushes the second support plate 204 causing the second plate 204, the release knob 210, and the shaft 212 to rotate about the hinge pin 206 away from the first plate 202 (e.g., toward the shaft slot 168) and against the spring force of the hinge spring 208 to a compressed position. During this rotation, the shaft 212 is moved through the shaft slot 168 toward the free/open end of the second support member 160. The movement of the support members 140, 160 continues and the second plate 204 slides along a lower/bottom surface of the first support member 140, which holds the second plate 204 in the compressed position. As generally illustrated in FIG. 5C, once the notch 148 and the second plate 204 become aligned with one another, the second plate 204 is no longer held in the compressed position and snaps into engagement with the notch 148 via the hinge spring 208 rotating the second plate 204, the release knob 210, and the shaft 212 about the hinge pin 206. During this rotation, the shaft 212 is moved through the shaft slot 168 away from the free/open end of the second support member 160.

An exemplary method of adjusting the support assembly 100 from the use position to the storage position includes disengaging the safety pin 108 from the cross member 190 and disengaging the lock mechanism 200 from the first support member 140. Disengaging the safety pin 108 from the cross member 190 includes removing the safety pin 108 from the safety pin recesses 146, 166. Disengaging the lock mechanism 200 from the first support member 140 includes actuating, adjusting, and/or moving the release knob 210 generally toward the free/open end of the second support member 160 to rotate the second plate 204 about the hinge pin 206 and remove the second plate 204 from the notch 148. While the safety pin 108 and the lock mechanism 200 are disengaged, the support members 140, 160 are moved away from one another to remove the first support member 140 from the internal space 162 of the second support member 160 via rotating the legs 110, 120 away from one another about the leg pin 120 (e.g., to the stopped position). The support members 140, 160 are then adjusted to the collapsed position via rotating each of the support members 140, 160 about the associated support pin 104, 106 toward the associated leg 110, 120. The legs 110, 120 are then adjusted (e.g., from the stopped position) to the folded position shown in FIG. 4A via rotating the legs 110, 120 toward one another about the leg pin 102. One or more of these steps may include performing one or more of the actions described with respect to the method of adjusting the support assembly 100 from the storage position to the use position in the opposite direction and/or in reverse order.

Optionally, the support assembly 100 may include a feed assembly 230 to hold and/or support the feed material 302 for the heat transfer printer and cutter 300 as illustrated in FIGS. 6-8B. The feed assembly 230 includes a first arm 232, a second arm 234, an adjustable roller 240, and a passive roller 242. The first arm 232 is connected to the first plate projection 176 via first arm screws 236. The second arm 234 is connected to the second plate projection 186 via second arm screws 238. The arms 232, 234 generally extend transversely (e.g., perpendicularly) to the legs 110, 120 and the support members 140, 160. The rollers 240, 242 extend between the arms 232, 234 and are substantially parallel to the cross member 190. The rollers 240, 242 are rotatably connected to the arms 232, 234 and, thus, are rotatable relative to the arms 232, 234. The speed at which the adjustable roller 240 may rotate and/or an amount of force needed to rotate the adjustable roller 240 is adjustable via a roller brake 244. The passive roller 242 is freely rotatable and, thus, the speed at which the passive roller 242 may rotate and/or an amount of force needed to rotate the passive roller 242 is not adjustable. The roller brake 244 includes a threaded shaft 246 and a plurality of friction gaskets 248a, 248b configured to apply resistance to the adjustable roller 240 to restrict and/or limit rotation of the adjustable roller 240. The threaded shaft 246 is connected to the first arm 232 and/or the adjustable roller 240. An adjustment knob 250 is connected to the threaded shaft 246. A user can actuate, turn, and/or twist the adjustment knob 250 to adjust the amount of resistance applied to the adjustable roller 240 by the roller brake 244 to make the adjustable roller 240 easier to rotate (e.g., rotatable with lesser force) or harder to rotate (e.g., rotatable with greater force).

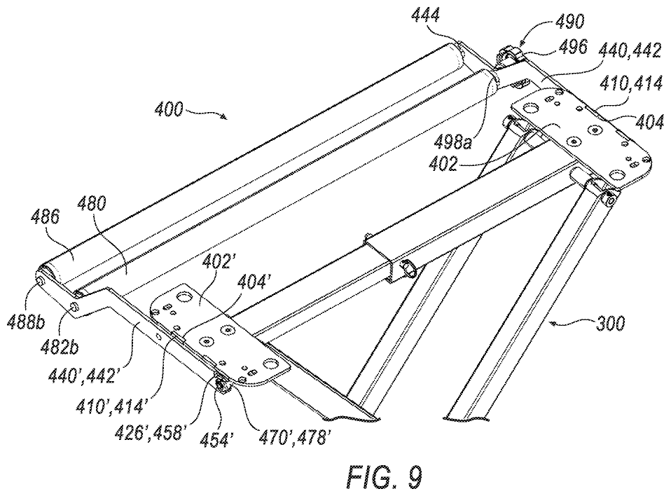

Referring now to FIGS. 9-14H, an exemplary support assembly 300 including a feed assembly 400 is shown. The support assembly 300 and the feed assembly 400 are substantially similar to the support assembly 100 and the feed mechanism 230 in most aspects, but differ with respect to the connection and/or mounting of the arms 440, 440′. More specifically, the arms 440, 440′ of the feed assembly 400 are releasably connectable to support assembly 300, the associated mounting plate 402, 402′, and/or the associated plate projection 410, 410′ via a respective snap-fit connection rather than via arm screws 236, 238 like the feed assembly 230. Connecting the arms 440, 440′ via snap-fit connections allows for the connection to be established without the use of tools (e.g., a screwdriver) and/or auxiliary components (e.g., screws), which greatly simplifies and/or speeds up the connection and/or mounting process.

The feed assembly 400 is releasably connected to the support assembly 300 and supports and/or retains feed material (e.g., a roll of feed material, such as a roll of multi-layer material that may include vinyl) in a similar manner to feed assembly 230. The feed assembly 400 includes a first arm 440 440, a second arm 440′ 440′, a plurality of retention rings 502, 522, 542, 562, an adjustable roller 480, a passive roller 486, a roller brake 490, and a plurality of friction gaskets 498A, 498B. The feed assembly 400 also includes the mounting plates 402, 402′ and/or the plate projections 410, 410′ (e.g., the brackets 410, 410′), which may therefore be considered elements and/or components of the feed assembly 400 and/or the support assembly 300. As explained in further detail below, the arms 440, 440′ generally extend transversely (e.g., perpendicularly) to the legs and the support members of the support assembly 300. The rollers 480, 486 extend between the arms 440, 440′ and are substantially parallel to the cross member of the support assembly 300. The rollers 480, 486 are rotatably connected to the arms 440, 440′ and, thus, are rotatable relative to the arms 440, 440′. The speed at which the adjustable roller 480 may rotate and/or an amount of force needed to rotate the adjustable roller 480 is adjustable via the roller brake 490. The passive roller 486 is freely rotatable and, thus, the speed at which the passive roller 486 may rotate and/or an amount of force needed to rotate the passive roller 486 is not adjustable.

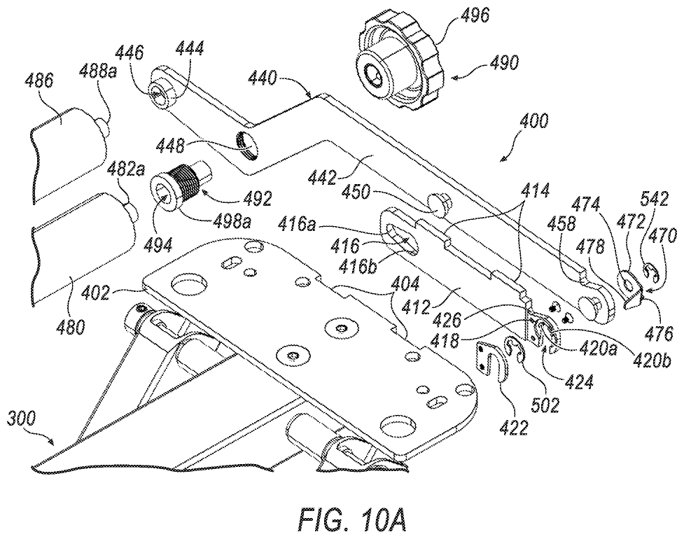

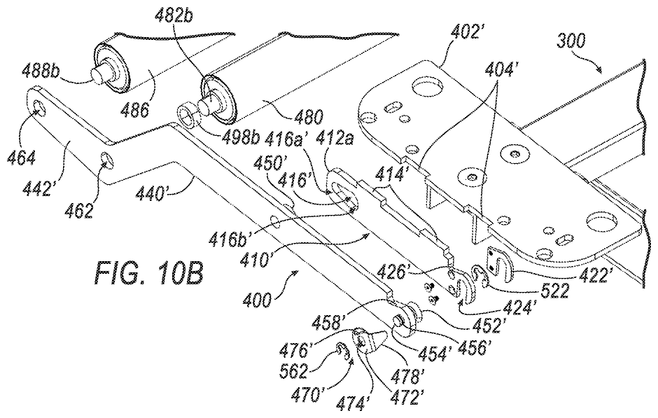

As generally shown in FIGS. 10A and 10B, the feed assembly 400 includes a first retention 502, a second retention ring 522, a third retention ring 542, and a fourth retention ring 562. The first retention ring 502 is connected to the first bracket 410 and releasably engages the snap-fit pin 452 of the first arm 440. The second retention ring 522 is connected to the second bracket 410′ and releasably engages the snap-fit pin 452′ of the second arm 440′. The third retention ring 542 is disposed on and connected to the stopper pin 454 of the first arm 440. The fourth retention ring 562 is disposed on and connected to the stopper pin 454′ of the second arm 440′. The retention rings 502, 522, 542, 562 are structured in substantially the same manner and, therefore, the following description of the first retention ring 502 is equally applicable to the other retention rings 522, 542, 562.

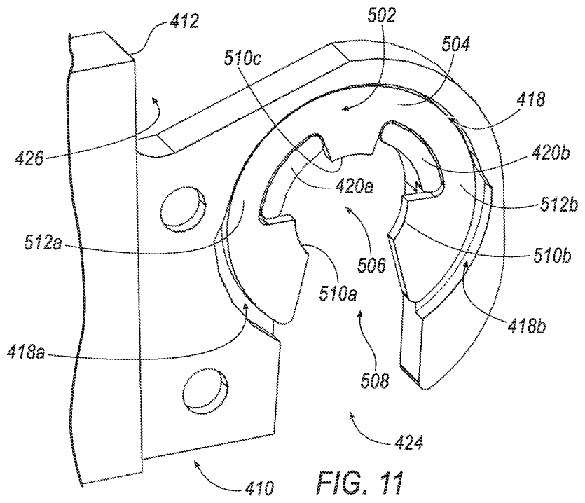

As generally shown in FIG. 11, the first retention ring 502 includes a ring body 504, an interior space 506, a ring opening 508, and a plurality of ring projections 510A-510C. The ring body 504 is a generally ring-shaped body that defines the interior space 506. The ring opening 508 extends between and connects the interior space 506 and the external surroundings of the ring body 504. The plurality of ring projections 510A-510C extend and/or protrude from the ring body 504 into the interior space 506 of the retention ring 502. The plurality of ring projections 510A-510C includes a first leg projection 510A, a second leg projection 510B, and a base projection 510C. The base projection 510C is arranged on the ring body 504 opposite the ring opening 508. A first ring leg 512A is defined by the portion of the ring body 504 extending from the base projection 510C to the ring opening 508 in a first circumferential direction. A second ring leg 512B is defined by the portion of the ring body 504 extending from the base projection 510C to the ring opening 508 in a second, opposite circumferential direction. The first leg projection 510A is disposed at a free end of the first ring leg 512A and at least partially defines the ring opening 508. The second leg projection 510B is disposed at a free end of the second ring leg 512B and at least partially defines the ring opening 508. The retention ring 502 flexes and/or elastically deforms to allow the retention ring 502 to engage (e.g., snap onto) and/or disengage an associated pin (e.g., the snap-fit pin 452 of the first arm 440).

As generally illustrated in FIGS. 9-10B, the mounting plates 402, 402′ are similar to the mounting plates 170, 180 in most aspects, but differ with respect to the configuration of the plate projections 410, 410′. Here, the plate projections 410, 410′ are configured and/or structured as brackets 410, 410′ (e.g., a first bracket 410 and a second bracket 410′) that are releasably connectable to the arms 440, 440′ via snap-fit connections rather than via arm screws 236, 238 (see, e.g., FIG. 7). The mounting plates 402, 402′ and screws releasably connect at least a portion of the feed assembly 300 (e.g., the mounting plates 402, 402′ and the brackets 410, 410′) to the support assembly 300 (e.g., the support members thereof).

As generally illustrated in FIGS. 9, 10A, and 14A-14H, the first bracket 410 is connected to the first mounting plate 402 and is releasably and adjustably connected to the first arm 440 to connect, attach, and/or secure the first arm 440 to the support assembly 300. The first bracket 410 includes a first bracket member 412, a plurality of mounting projections 414, a slot 416, the first retention ring 502, a ring depression 418, one or more retention protrusions 420A, 420B, a bracket cover 422, an aperture 424, and a stopper notch 426. The first bracket 410 is connected and/or fixed to the first mounting plate 402 via a weld connection. Conceivably, the first bracket 410 may be releasably connected to the first mounting plate 402 and, in such configurations, the first mounting plate 402 may not be a component and/or element of the feed assembly 400.

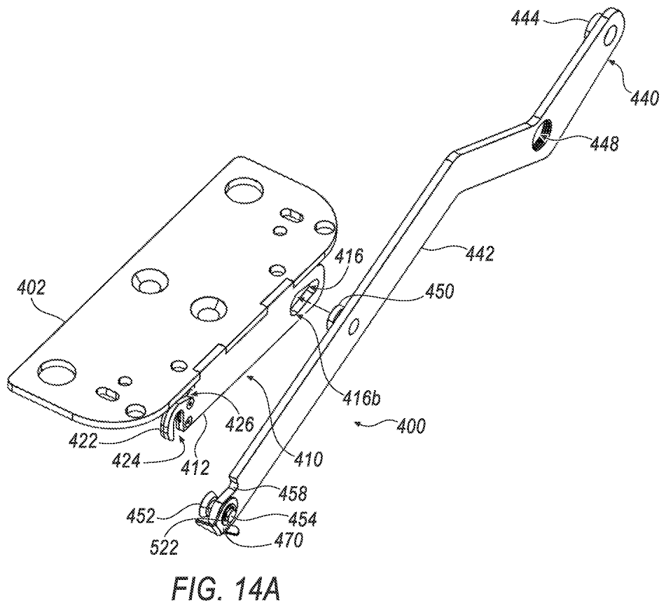

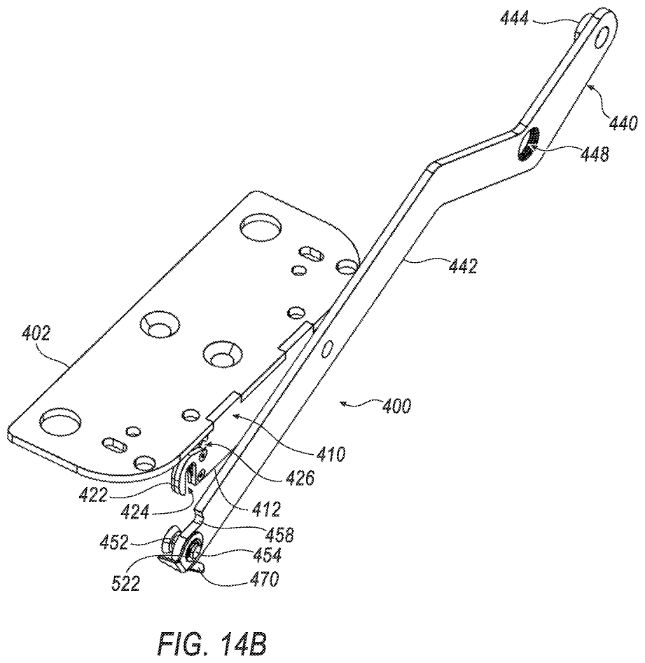

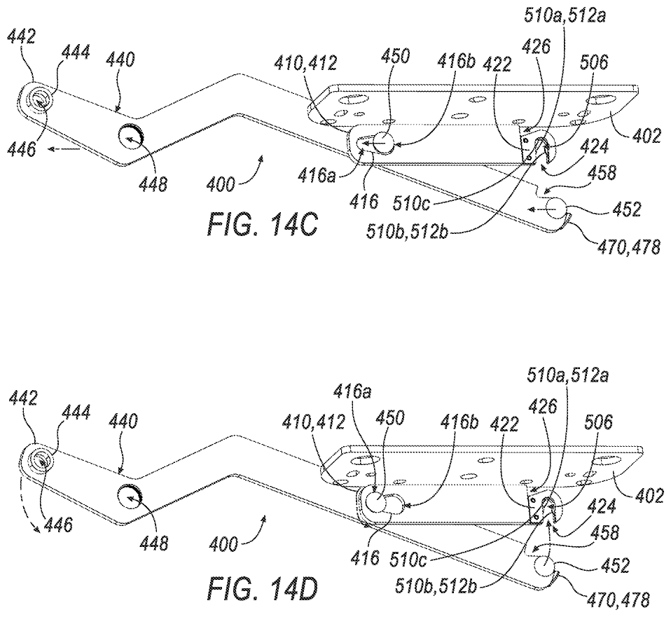

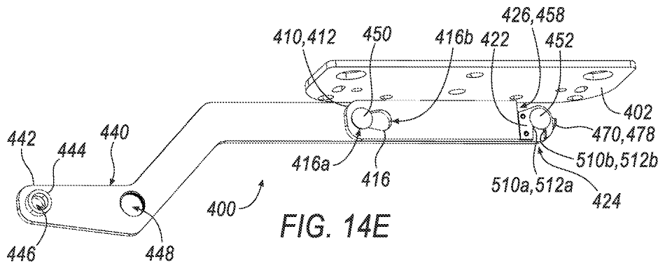

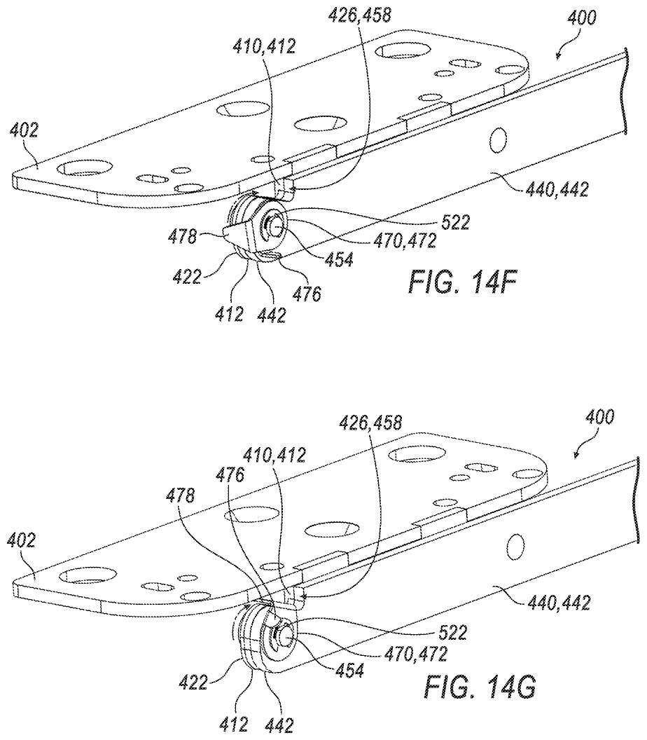

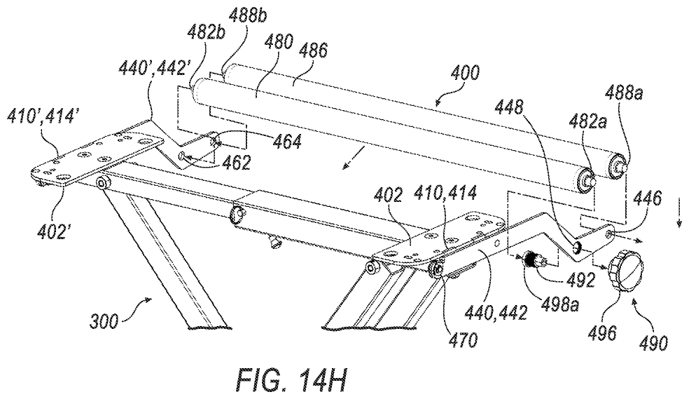

As generally illustrated in FIGS. 10A and 14A-14H, the first bracket member 412 is structured as an elongated member, such as a solid bar. A first end of the first bracket 410 and/or the first bracket member 412 is releasably connectable and/or connected to the first arm 440 via engagement of the aperture 424 and the first retention ring 502 with the first arm 440 (e.g., the snap-fit pin 452 thereof). A second end of the first bracket 410 and/or the first bracket member 412 is releasably and adjustably connectable and/or connected to the intermediate region of the first arm 440 and/or the first arm member 442 via engagement of the slot 416 and the first arm 440 (e.g., the slot pin 450 thereof). An upper end of the first bracket 410 and/or the first bracket member 412 is connected to the first mounting plate 402 at least via the mounting projections 414 and/or one or more welds (i.e., a weld connection).

As generally illustrated in FIG. 10A, the plurality of mounting projections 414 are disposed spaced apart from one another and project from the upper end of the first bracket 410 and/or the first bracket member 412. The mounting projections 414 are integrally formed with the first bracket member 412. The mounting projections 414 are structured and arranged in a complimentary manner to recesses 404 of the first mounting plate 402. The mounting projections 414 are received by the recesses 404 of the first mounting plate 402, which ensures proper positioning of the first bracket 410 relative to the first mounting plate 402, and are connected to the first mounting plate 402 via one or more welds.

As generally illustrated in FIGS. 10A and 14A-14E, the slot 416 selectively receives the slot pin 450 of the first arm 440 and, thereby, releasably and adjustably (e.g., slidably, rotatably, and/or pivotably) connects the first arm 440 to the first bracket 410. The slot 416 is disposed in and defined by the first bracket member 412 and/or one or more surfaces thereof. The slot 416 is arranged at or about the second end of the first bracket 410 and/or the first bracket member 412. The slot 416 is generally ovoid (e.g., egg-like) in shape and has a narrow end 416A and a wide end 416B disposed opposite one another. The width of the slot 416 (e.g., measured in a vertical direction) is larger at the wide end 416B than at the narrow end 416A, and the width of the slot 416 gradually decreases from the wide end 416B to the narrow end 416A. The slot pin 450 of the first arm 440 is insertable into and removable from the slot 416 at the wide end 416B. The slot pin 450 of the first arm 440 is not insertable into nor removable from the slot 416 at one or more regions of the slot 416, such as at or about the narrow end 416A of the slot 416.

As generally illustrated in FIGS. 10A and 11, the ring depression 418 receives and retains the first retention ring 502, which selectively receives and retains a portion of the first arm 440 (e.g., the snap-fit pin 452 thereof). The ring depression 418 is defined by the first bracket member 412 and/or one or more surfaces thereof. The ring depression 418 is disposed in and/or projects into an interior surface of the first bracket member 412 facing away from the first arm 440. The ring depression 418 is arranged at or about the first end of the first bracket 410 and/or the first bracket member 412. The ring depression 418 includes a plurality of compensation regions (e.g., a first compensation region 418A and a second compensation region 418B) into which the ring legs 512A, 512B of the first retention ring 502 are adjusted (e.g., flex) when a portion of the snap-fit pin 452 is pressed into the ring opening 508 and against the ring legs 512A, 512B (e.g., during insertion and/or removal of the snap-fit pin 452 from the interior space 506 of the first retention ring 502). The radial dimension on the ring depression 418 is larger in the compensation regions 418A, 418B than in regions outside of the compensation regions 418A, 418B. A plurality of retention protrusions 420A, 420B extend and/or protrude from the first bracket member 412 into the ring depression 418. A first retention protrusion 420A is disposed between the base projection 510C and the first leg projection 510A of the first retention ring 502. A second retention protrusion 420B is disposed between the base projection 510C and the second leg projection 510B of the first retention ring 502. The retention protrusions 420A, 420B engage the first retention ring 502 and effectively maintain an orientation of the first retention ring 502 within the ring depression 418 (e.g., restrict and/or effectively prevent rotation of the first retention ring 502). The bracket cover 422 is disposed on and connected to the first bracket member 412, and at least partially closes the ring depression 418 thereby securing the first retention ring 502 in the ring depression 418 and connecting the first retention ring 502 to the first bracket 410. The bracket cover 422 is connected to the first bracket member 412 by a plurality of cover screws, which are disposed in aligned screw holes of the bracket cover 422 and the first bracket member 412.

As generally illustrated in FIGS. 10A, 12, and 14A-14E, the aperture 424 selectively receives a portion of the first arm 440 (e.g., the snap-fit pin 452 thereof). The aperture 424 is defined by the first bracket member 412, the bracket cover 422, and/or one or more surfaces thereof. The aperture 424 is arranged at or about the first end of the first bracket 410 and/or the first bracket member 412, and opens through a lower end of the first bracket 410. The aperture 424 projects and/or extends into the ring depression 418 from the lower end of the first bracket member 412 and/or the first bracket 410. The ring projections 510A-510C extend and/or project into the aperture 424 at or about a closed end thereof and, thus, are able to engage (e.g., contact and/or abut) the snap-fit pin 452 of the first arm 440 to connect the first arm 440 to the first bracket 410. The aperture 424 and the ring opening 508 of the first retention ring 502 are aligned with one another thereby enabling the snap-fit pin 452 to engage and/or disengage the first retention ring 502 (e.g., via insertion into and/or removal from the interior space 506 of the first retention ring 502) by way of the aperture 424.

As generally illustrated in FIGS. 10A, 11, and 14C-14H, the stopper notch 426 is disposed in and defined by the first bracket member 412, the bracket cover 422, and/or one or more surfaces thereof. The stopper notch 426 is arranged at or about the first end of the first bracket 410 and/or the first bracket member 412, and is positioned near and/or adjacent to the aperture 424. The stopper notch 426 selectively receives a portion of the safety stopper 470 (e.g., the stop flange 478 thereof). The stopper notch 426 includes at least one open end via which the stop flange 478 of the safety stopper 470 is insertable into and removable from the stopper notch 426.

As generally illustrated in FIGS. 9 and 10B, the second bracket 410′ is connected to the second mounting plate 402′ and is releasably and adjustably connected to the second arm 440′ to connect, attach, and/or secure the second arm 440′ to the support assembly 300. The second bracket 410′ is effectively a mirror image of the first bracket 410 and is configured in a substantially similar manner to the first bracket 410. The second bracket 410′ includes a second bracket member 410′, a plurality of mounting projections 414′, a slot 416′ with a narrow end 416A′ and a wide end 416B′, the second retention ring 522, a ring depression, one or more retention protrusions, a bracket cover 422′, an aperture 424′, and a stopper notch 426′. The second bracket 410′ member, mounting projections 414′, slot 416′, second retention ring 522, ring depression, retention protrusions 420A′, 420B′, bracket cover 422′, aperture 424′, and stopper notch 426′ of the second bracket 410′ are structured and arranged, function, and/or interact with associated structures (e.g., of the second mounting plate 402′ and/or of the second arm 440′) in the same or a substantially similar manner to the corresponding features of the first bracket 410 and, therefore, are not described in detail for brevity.

As generally illustrated in FIGS. 9, 10A, 12A, 12B, 13A, and 14A-14H, the first arm 440 is releasably connected to the first bracket 410, the rollers 480, 486, and the roller brake 490. The first arm 440 includes a first arm member 442, a roller boss 444, a brake recess 448, a stopper notch 458, a slot pin 450, a snap-fit pin 452, a stopper pin 454, the third retention ring 542, and a safety stopper 470.

As generally illustrated in FIGS. 9 and 10A, the first arm member 442 is structured as an elongated member, such as a solid bar or hollow tube. The first arm member 442 has an inner surface facing toward the first bracket 410 and/or the second arm 440′, and an outer surface facing away from the first bracket 410 and/or the second arm 440′. The first arm 440 and/or the first arm member 442 has a first longitudinal end, a second longitudinal end (e.g., a free end), and an intermediate region disposed therebetween. The intermediate region of the first arm 440 and/or the first arm member 442 is releasably and adjustably connectable to the first bracket 410 via engagement of the slot pin 450 and the first bracket 410 (e.g., the slot 416 thereof). The first end of the first arm 440 and/or the first arm member 442 is releasably connectable and/or connected to the first bracket 410 via engagement of the snap-fit pin 452 and the first bracket 410 (e.g., the first retention ring 502 and/or the aperture 424 thereof). The second end of the first arm 440 and/or the first arm member 442 is releasably and rotatably connectable and/or connected to the rollers 480, 486.

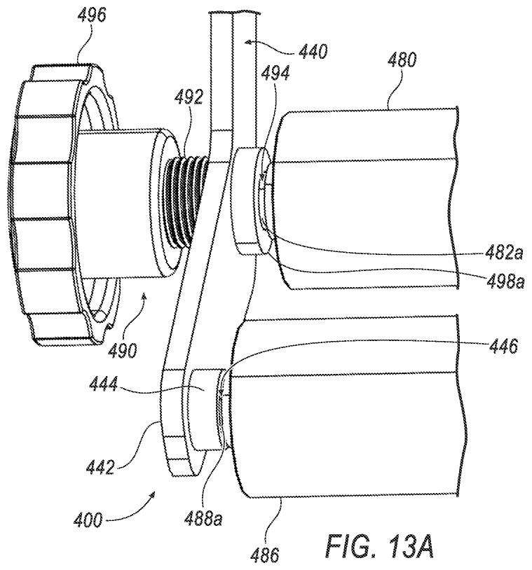

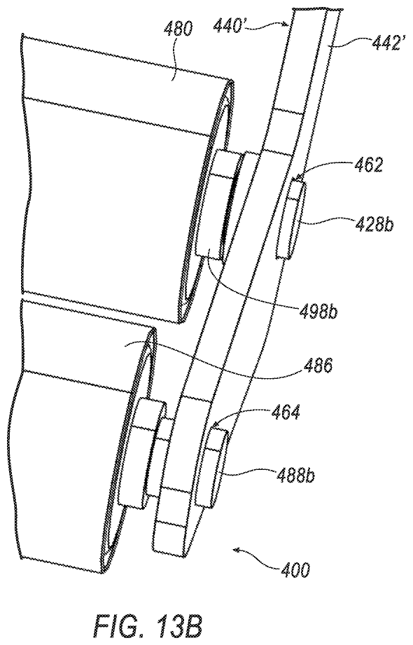

As generally illustrated in FIGS. 10A and 13A, the roller boss 444 is an elongated annular body arranged at or about the second end of the first arm 440 and/or the first arm member 442. The roller boss 444 is disposed on and projects from the inner surface of the first arm member 442 toward the second arm 440′. The roller boss 444 defines a roller cavity 446 that receives a portion of the passive roller 486. In this manner, the roller boss 444 releasably and rotatably engages the passive roller 486 and, thereby, rotatably connects the passive roller 486 to the first arm 440 and/or the first arm member 442.

As generally illustrated in FIGS. 10A, 13A, and 14H, the brake recess 448 is disposed in and defined by the first arm member 442 and/or one or more surfaces thereof. The brake recess 448 is arranged in the intermediate region of the first arm 440 and/or the first arm member 442 and is positioned near and/or adjacent to the roller boss 444 such that the rollers 480, 486 are able to simultaneously support the feed material (e.g., the same roll of feed material). The brake recess 448 receives a portion of the roller brake 490 (e.g., the threaded shaft 492 thereof). The first arm member 442 and/or the brake recess 448 includes an internal helical thread, which is disposed in and/or projects into the brake recess 448. The internal thread of the brake recess 448 is adjustably engaged with the external thread of the threaded shaft 492, which connects the threaded shaft 492 and the roller brake 490 to the first arm 440.

As generally illustrated in FIGS. 10A, 12A, 12B, 14F, and 14G, the stopper notch 458 is disposed in and defined by the first arm member 442 and/or one or more surfaces thereof. The stopper notch 458 is arranged at or about the first end of the first arm 440 and/or the first arm member 442, and is positioned near and/or adjacent to the snap-fit pin 452. The stopper notch 458 selectively receives a portion of the safety stopper 470 (e.g., the stop flange 478 thereof). The stopper notch 458 includes at least one open end via which the stop flange 478 of the safety stopper 470 is insertable into and removable from the stopper notch 458.

As generally illustrated in FIGS. 10A, 14A, and 14C-14E, the slot pin 450 releasably and adjustably (e.g., slidably, rotatably, and/or pivotably) engages the first bracket 410 (e.g., via the slot 416 thereof) to establish a releasable and adjustable (e.g., pivotable, rotatable) connection between the first arm 440 (e.g., the intermediate region thereof) and the first bracket 410. The slot pin 450 is arranged in the intermediate region of the first arm 440 and/or the first arm member 442 and, within the intermediate region, is offset toward the first end of the first arm 440 and/or the first arm member 442. The slot pin 450 is disposed on and projects (e.g., perpendicularly) from the inner surface of the first arm member 442 toward the first bracket 410.

The slot pin 450 is insertable into, removable from, and adjustable within the slot 416 of the first bracket 410 thereby allowing the first arm 440 to be releasably and adjustably connected to the first bracket 410. The slot pin 450 is insertable into and removable from the slot 416 (e.g., in an axial direction of the slot pin 450) at the wide end 416B of the slot 416. The slot pin 450 is not insertable into, nor removable from the slot 416 (e.g., in the axial direction of the slot pin 450) at one or more regions of the slot 416, such as at or about the narrow end 416A of the slot 416.

As generally illustrated in FIGS. 14C-14E, when the slot pin 450 is disposed in the slot 416, the slot pin 450 is moveable, adjustable, and/or slidable within the slot 416. The slot pin 450 can be adjusted translationally (i.e., translational motion) within the slot 416, such as toward the narrow end 416A of the slot 416 and/or toward the wide end 416B of the slot 416. The slot pin 450 can also be adjusted rotationally (i.e., rotational motion) within the slot 416, such as by adjusting and/or moving the first arm 440. The slot pin 450 rotatably and/or pivotably connects the first arm 440 to the first bracket 410 and functions and/or serves as a pivot point and/or a pivot axis about which the first arm 440 may be adjusted, pivoted, and/or rotated. When the slot pin 450 is disposed in the slot 416 and arranged at the narrow end 416A of the slot 416, the snap-fit pin 452, the aperture 424 of the first bracket 410, and the ring opening 508 of the first retention ring 502 are aligned with one another relative to a circumferential direction (e.g., extending about the slot pin 450) such that the first arm 440 can be pivoted and/or rotated about the slot pin 450 to move and/or adjust the snap-fit pin 452 into engagement with the first bracket 410 to establish the snap-fit connection of the first arm 440 to the first bracket 410.

As generally illustrated in FIGS. 10A and 14C-14E, the slot pin 450 includes a pin shaft and a pin head. The pin shaft is disposed on, connected to, and projects from the inner surface of the first arm member 442 toward the first bracket 410. The pin head is disposed at and connected to an end of the pin shaft opposite the first arm member 442. When the slot pin 450 is engaged with the first bracket 410 (e.g., is disposed in the slot 416), the pin shaft is disposed in and extends through the slot 416 such that the first bracket 410 is disposed between the first arm member 442 and the pin head. An outer diameter of the pin head is greater than an outer diameter of the pin shaft. The outer diameter of the pin head is smaller than the dimensions of the slot 416 (e.g., the width) at the wide end 416B thereby enabling the slot pin 450 to be inserted into and removed from the slot 416 at the wide end 416B. The outer diameter of the pin shaft substantially corresponds to and/or is slightly smaller than the dimensions of the slot 416 (e.g., the width) at the narrow end 416A thereby enabling the slot pin 450 (e.g., the pin shaft) to be arranged at or about the narrow end 416A of the slot 416. The outer diameter of the pin head is greater than the dimensions of the slot 416 at the narrow end 416A. As a result, when the slot pin 450 is disposed in the slot 416 and arranged at the narrow end 416A, the pin head and the first arm 440 prevent the slot pin 450 from being removed from the slot 416.

As generally illustrated in FIGS. 10A, 12A, 12B, and 14A-14E, the snap-fit pin 452 releasably engages the first bracket 410 (e.g., via the aperture 424 thereof) and/or the first retention ring 502 thereof to establish a releasable snap-fit connection between the first arm 440 and the first bracket 410. The snap-fit pin 452 is disposed at, about, and/or adjacent to the first end of the first arm 440 and/or the first arm member 442. The snap-fit pin 452 is disposed on and projects (e.g., perpendicularly) from the inner surface of the first arm member 442 toward the first bracket 410. The snap-fit pin 452 includes a pin shaft and a pin head. The pin shaft is disposed on, connected to, and projects from the inner surface of the first arm 440 toward the first bracket 410. The pin head is disposed at and connected to a free end of the pin shaft opposite the first arm 440. The pin head includes a tapered outer circumferential surface that is inwardly sloped toward the pin shaft, which may contact the first bracket 410 and/or the bracket cover 422 and help guide the snap-fit pin 452 into the aperture 424 of the first bracket 410 and/or the interior space 506 of the first retention ring 502 during assembly. An outer diameter of the pin head is greater than an outer diameter of the pin shaft. As a result, when the snap-fit pin 452 and the first bracket 410 are engaged, the pin head and the first arm member 442 effectively prevent the first arm 440 and the first bracket 410 from disconnecting in the axial direction of the snap-fit pin 452.

When the first arm 440 is connected to the first bracket 410 via the snap-fit connection, (i) the first bracket 410, the first retention ring 502, and the bracket cover 422 are disposed between the first arm member 442 and the pin head relative to an axial direction of the snap-fit pin 452 and (ii) the pin shaft is disposed in the aperture 424 of the first bracket 410 and engaged with the first retention ring 502. When the snap-fit pin 452 is engaged with the first retention ring 502 (e.g., when the first retention ring 502 is disposed and/or snapped onto the snap-fit pin 452), the pin shaft is disposed in an interior space 506 of the first retention ring 502 and engaged (e.g., contacted and/or abutted) by the ring projections 510A-510C of the first retention ring 502, which releasably connects and/or secures the first arm 440 to the first bracket 410.

As generally illustrated in FIGS. 10A, 12A, 12B, 14A, 14B, 14F, and 14G, the stopper pin 454 is disposed at, about, and/or adjacent to the first end of the first arm 440 and/or the first arm member 442. The stopper pin 454 is disposed on and projects (e.g., perpendicularly) from the outer surface of the first arm member 442 away from the first bracket 410. As such, the stopper pin 454 and the snap-fit pin 452 project from the first arm 440 and/or the first arm member 442 in opposite directions. The stopper pin 454 and the snap-fit pin 452 are also arranged coaxially, though this is optional. In addition, the stopper pin 454 and the snap-fit pin 452 may be (i) defined and/or formed by portions of a single (e.g., monolithic) pin connected (e.g., welded) to the first arm member 442, (ii) separate, individual pins connected (e.g., welded) to the first arm member 442, or (iii) integral portions of the first arm member 442.

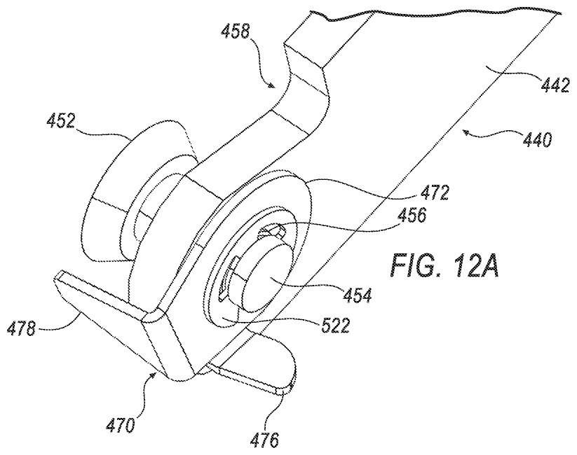

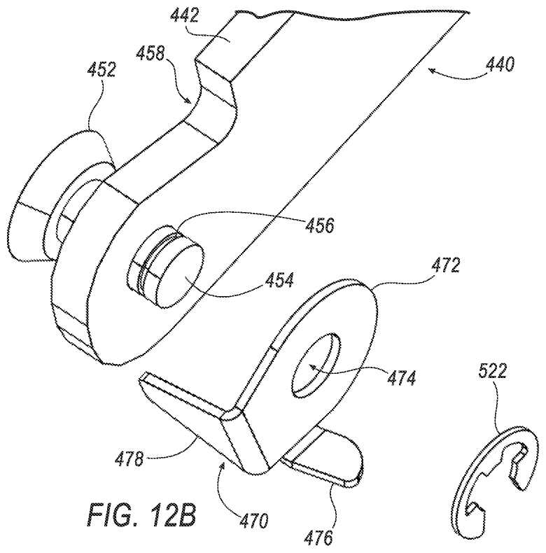

As generally illustrated in FIG. 12B, the stopper pin 454 is a generally cylindrical body and includes a ring groove 456 that receives at least a portion of the third retention ring 542. The ring groove 456 is disposed in the outer circumferential surface of the stopper pin 454 and extends circumferentially around (e.g., completely around) the stopper pin 454. The ring groove 456 is arranged between and spaced apart from a fixed end of the stopper pin 454 connected to the first arm member 442 and a free end of the stopper pin 454 opposite the first arm member 442.

As generally illustrated in FIGS. 12A and 12B, the stopper pin 454 releasably and/or adjustably (e.g., rotatably and/or pivotably) connects the safety stopper 470 and the third retention ring 542 to the first arm member 442. The third retention ring 542 is engaged with the stopper pin 454 such that the stopper pin 454 is disposed in the interior space of the third retention ring 542 and engaged (e.g., contacted and/or abutted) by the ring projections of the third retention ring 542, which releasably connects and/or secures the third retention ring 542 to the stopper pin 454. The third retention ring 542 and/or the ring projections thereof are disposed in and/or project into the ring groove 456, which restricts relative movement between the third retention ring 542 and the stopper pin 454 in the axial direction of the stopper pin 454 and secures and/or connects the safety stopper 470 to the stopper pin 454. The stopper pin 454 is disposed in and extends through the pin opening 474 of the safety stopper 470 such that the safety stopper 470 is adjustable (e.g., rotatable and/or pivotable) about the stopper pin 454. The safety stopper 470 is disposed on the stopper pin 454 between the first arm member 442 and the third retention ring 542 relative to the axial direction of the stopper pin 454, which effectively prevents the first arm 440 and the safety stopper 470 from disconnecting in the axial direction of the stopper pin 454 while simultaneously allowing the safety stopper 470 to rotate and/or pivot about the stopper pin 454.

As generally illustrated in FIGS. 10A, 12A, 12B, 14A, 14B, 14F, and 14G, the safety stopper 470 selectively restricts and/or prevents adjustment and/or movement of the first arm 440 relative to the first bracket 410 (e.g., pivoting and/or rotation of the first arm 440 about the slot pin 450), which in turn restricts and/or effectively prevents the snap-fit pin 452 of the first arm 440 from disengaging the first bracket 410 and/or the third retention ring 542 (e.g., via being removed from the aperture 424 of the first bracket 410 and the interior space 506 of the third retention ring 542). This may reduce the risk of injury and/or property damage due to the first arm 440 disengaging the first bracket 410 inadvertently and/or unintentionally (e.g., as a result of user error and/or component failure).

As generally illustrated in FIGS. 12A and 12B, the safety stopper 470 (e.g., the main body 472 thereof) is adjustably arranged on the stopper pin 454 axially between (i) the first arm 440 and (ii) the ring groove 456 and the third retention ring 542. The safety stopper 470 is rotatable and/or pivotable about the stopper pin 454 to a locked position (see, e.g., FIGS. 14G-14H) and to an unlocked position (see, e.g., FIGS. 12A, 14A-14F). When in the locked position, the safety stopper 470 is engaged with the first bracket 410 and restricts and/or effectively prevents adjustment and/or movement of the first arm 440 relative to the first bracket 410 (e.g., pivoting and/or rotation of the first arm 440 about the slot pin 450). When in the unlocked position, the safety stopper 470 is disengaged from the first bracket 410 thereby allowing adjustment and/or movement of the first arm 440 relative to the first bracket 410 (e.g., pivoting and/or rotation of the first arm 440 about the slot pin 450). In other words, the safety stopper 470 is rotatable and/or pivotable about the stopper pin 454 to selectively engage the first bracket 410.

The safety stopper 470 includes a main body 472, a pin opening 474, an actuation flange 476, and a stop flange 478. The main body 472 is a generally planar body that extends substantially parallel to the first arm member 442 and transversely (e.g., perpendicularly) to the stopper pin 454. The pin opening 474 is disposed in and defined by the main body 472. The main body 472 is adjustably arranged on the stopper pin 454 such that the stopper pin 454 is disposed in and extends through the pin opening 474.

The actuation flange 476 facilitates user interaction with and/or user actuation of the safety stopper 470. The actuation flange 476 is configured to be grasped, held, pushed, pulled, or otherwise engaged by a user to adjust, rotate, and/or pivot the safety stopper 470 about the stopper pin 454 (e.g., to the locked position and/or to the unlocked position). The stop flange 478 selectively engages the first bracket 410 (e.g., the stopper notch 426 thereof) to restrict and/or prevent relative movement between and/or disengagement of the first arm 440 (e.g., the snap-fit pin 452) and the first bracket 410 (e.g., via removal of the snap-fit pin 452 from the aperture 424 of the first bracket 410). The flanges 476, 478 are connected to and project (e.g., transversely, obliquely, and/or perpendicularly) from the main body 472. The actuation flange 476 projects perpendicularly from the main body 472 generally away from the first bracket 410. The stop flange 478 projects perpendicularly from the main body 472 generally toward the first bracket 410. The flanges 476, 478 are each formed and/or defined by a bent portion of the main body 472 and, thus, are integrally connected to the main body 472.

As generally illustrated in FIG. 14G-14H, when the safety stopper 470 is in the locked position, the stop flange 478 is disposed in the stopper notch 426 of the first bracket 410 and the stopper notch 458 of the first arm member 442 simultaneously. The stop flange 478 may engage, contact, and/or rest on a surface of the first bracket 410 (e.g., that defines the stopper notch 426) and/or a surface of the first arm member 442 (e.g., that defines the stopper notch 458) when disposed in the stopper notches 426, 458. At least a portion of the first bracket 410 is disposed between the stop flange 478 and the snap-fit pin 452 relative to a removal direction of the snap-fit pin 452 (i.e., the direction in which the snap-fit pin 452 is moved and/or adjusted during removal from the aperture 424 of the first bracket 410). As a result, if a force is applied to the first arm 440 and/or the first arm member 442 that would be sufficient to disengage the snap-fit pin 452 from the first retention ring 502, the stop flange 478 engages, contacts, abuts, and/or presses against the first bracket 410 (e.g., a surface thereof that defines the stopper notch 426), which restricts and/or effectively prevents (i) the snap-fit pin 452 from disengaging the first retention ring 502 and/or being removed from the aperture 424 in the removal direction and (ii) the first arm 440 from disengaging the first bracket 410.

As generally illustrated in FIGS. 12A, 12B, and 14A-14F, when the safety stopper 470 is in the unlocked position, the stop flange 478 is disposed outside of (i.e., is not disposed in) the stopper notch 426 of the first bracket 410 and, optionally, is disposed outside of the stopper notch 458 of the first arm 440. The stop flange 478 is offset from the first bracket 410 (e.g., the second end thereof) relative to the removal direction of the snap-fit pin 452 such that the stop flange 478 is able to pass by the second end of the first bracket 410, thereby enabling the snap-fit pin 452 to be removed from the aperture 424 of the first bracket 410 in the removal direction if a force is applied to the first arm 440 and/or the first member that is sufficient to disengage the snap-fit pin 452 from the first retention ring 502.

As generally illustrated in FIGS. 9 and 10B, the second arm 440′ is effectively a mirror image of the first arm 440 except the second arm 440′ has a plurality of roller recesses (e.g., an adjustable roller recess 462 and a passive roller recess 464) rather than a roller boss 444 and a brake recess 448. The second arm 440′ includes a second arm member 442′, a stopper notch 458′, a slot pin 450′, a snap-fit pin 452′, a stopper pin 454′, the fourth retention ring 562, a safety stopper 470′, and a plurality of roller recesses 462, 464. The second arm member 442′, stopper notch 458′, slot pin 450′, snap-fit pin 452′, stopper pin 454′, fourth retention ring 562, and safety stopper 470′ of the second arm 440′ are structured and arranged, function, and/or interact with associated structures (e.g., of the second bracket 410′) in the same or a substantially similar manner to the corresponding features of the first arm 440 and, therefore, are not described in detail for brevity.

As generally illustrated in FIGS. 9, 10B, 13B, 14H, and 14H, the plurality of roller recesses includes an adjustable roller recess 462 and a passive roller recess 464. The roller recesses 462, 464 are disposed in and defined by the second arm member 442′ and/or one or more surfaces thereof. The adjustable roller recess 462 and the passive roller recess 464 are arranged at or about the second end of the second arm 440′ and/or the second arm member 442′. The passive roller recess 464 is positioned near and/or adjacent to the adjustable roller recess 462 such that the rollers 480, 486 are able to simultaneously support the feed material. The adjustable roller recess 462 receives a portion of the adjustable roller 480 and, thereby, adjustably (e.g., rotatably) connects the adjustable roller 480 to the second arm 440′ and/or the second arm member 442′. The passive roller recess 464 receives a portion of the passive roller 486 and, thereby, rotatably connects the passive roller 486 to the second arm 440′ and/or the second arm member 442′. The adjustable roller recess 462, the adjustable roller 480 (e.g., the retractable pins 482A, 482B), the brake recess 448, the threaded shaft 492, and the shaft cavity 494 are disposed substantially coaxially when the feed assembly 400 is connected to the support assembly 300 and fully assembled. The passive roller recess 464, the passive roller 486 (e.g., the retractable pins 488A, 488B), the roller boss 444, and the roller cavity 446 are disposed substantially coaxially when the feed assembly 400 is connected to the support assembly 300 and fully assembled.

As generally illustrated in FIGS. 10A, 10B, 13A, and 13B, the one or more friction gaskets includes a first friction gasket 498A and a second friction gasket 498B. The first friction gasket 498A is connected to and/or a portion of the threaded shaft 492 of the roller brake 490. The first friction gasket 498A is pressed against the adjustable roller 480 (e.g., via actuating the roller brake 490) to apply force and/or pressure to the adjustable roller 480 to facilitate friction generation and, thereby, adjust and/or control rotation of the adjustable roller 480. The second friction gasket 498B is a generally annular body and is disposed on the adjustable roller 480 (e.g., the second retractable pin 482B thereof). Optionally, a size and/or a material of one or more of the friction gaskets 498A, 498B is selected to satisfy one or more contact area, roughness, hardness, and/or durability thresholds or standards.

As generally illustrated in FIGS. 9-10B, 13A, 13B, and 14H, the rollers 480, 486 are rotatably connected to the arms 440, 440′ and, thus, are rotatable relative to the arms 440, 440′. The speed at which the adjustable roller 480 may rotate and/or an amount of force needed to rotate the adjustable roller 480 is adjustable via the roller brake 490. The passive roller 486 is freely rotatable and, thus, the speed at which the passive roller 486 may rotate and/or an amount of force needed to rotate the passive roller 486 is not adjustable.

As generally illustrated in FIGS. 10A, 10B, 13A, and 13B, the rollers 480, 486 each have two retractable, spring-loaded pins (e.g., a first retractable pin 482A, 488A and a second retractable pin 482B, 488B) disposed at opposite ends of the respective roller 480, 486. The first retractable pin 482A of the adjustable roller 480 is removably and rotatably received in the shaft cavity 494 of the roller brake 490, which rotatably connects the adjustable roller 480 to the roller brake 490 and to the first arm 440 (e.g., via the roller brake 490). The second retractable pin 482B of the adjustable roller 480 is removably and rotatably received in the adjustable roller recess 462 of the second arm 440′, which rotatably connects the adjustable roller 480 to the second arm 440′. The first retractable pin 488A of the passive roller 486 is removably and rotatably received in the roller boss 444 and/or the roller cavity 446 of the first arm 440, which rotatably connects the passive roller 486 to the first arm 440. The second retractable pin 488B of the adjustable roller 480 is removably and rotatably received in the passive roller recess 464 of the second arm 440′, which rotatably connects the passive roller 486 to the second arm 440′. The second friction gasket 498B is disposed on the second retractable pin 482B.

Relative to the respective roller 480, 486, the retractable pins 482A, 482B, 488A, 488B are axially adjustable and/or moveable to an extended position and a retracted position. When the retractable pin 482A, 482B, 488A, 488B is in the extended position, a smaller portion of the retractable pin 482A, 482B, 488A, 488B is disposed in the respective roller 480, 486 and/or the retractable pin 482A, 482B, 488A, 488B projects a farther distance from the end of the respective roller 480, 486 relative to when in the retracted position. The retractable pin 482A, 482B, 488A, 488B is adjustable to the retracted position (e.g., from the extended position) via application of an axial force, such as by a user pressing/pushing on the retractable pin 482A, 482B, 488A, 488B. The retractable pin 482A, 482B, 488A, 488B is spring-loaded and, thus, biased toward the extended position via a spring. As such, the spring automatically moves, adjusts, and/or returns the retractable pin 482A, 482B, 488A, 488B to the extended pin when the axial force is removed. Adjusting the first retractable pin 482A, 488A and/or the second retractable pin 482B, 488B to and/or toward the retracted position enables the first retractable pin 482A, 488A and/or the second retractable pin 482B, 488B to be inserted into and/or removed from the associated recess 462, 464 and/or cavity 494, 446 to connect and/or disconnect the respective roller 480, 486 from one or more of the arms 440, 440′.

As generally illustrated in FIGS. 9, 10A, 13A, and 14H, the roller brake 490 is configured to apply adjustable resistance to the adjustable roller 480 to restrict and/or limit rotation of the adjustable roller 480 and, thereby, adjust the speed at which the adjustable roller 480 may rotate and/or adjust an amount of force needed to rotate the adjustable roller 480. The roller brake 490 is adjustably connected to the first arm 440 and rotatably and/or pivotably connected to the adjustable roller 480 (e.g., via the first retractable pin 482A). The roller brake 490 includes a threaded shaft 492, a shaft cavity 494, an adjustment knob 496, and the first friction gasket 498A. The threaded shaft 492 includes an external helical thread projecting radially therefrom. A first axial end of the threaded shaft 492 is releasably connected to the adjustment knob 496 (e.g., via the external thread). An opposite, second axial end of the threaded shaft 492 is connected to the first friction gasket 498A. The shaft cavity 494 is defined at least partially by the threaded shaft 492 and/or the first friction gasket 498A, and projects axially into the second axial end of the threaded shaft 492. The shaft cavity 494 releasably and rotatably receives the first retractable pin 482A of the adjustable roller 480 and, thus, the roller brake 490 is rotatably connected to the adjustable roller 480. In this manner, the adjustable roller 480 is rotatably connected to the first arm 440 via the roller brake 490. The threaded shaft 492 is disposed in the brake recess 448 of the first arm 440 with its external threads adjustably engaged with the internal thread of the brake recess 448, which adjustably connects the threaded shaft 492 and the roller brake 490 to the first arm 440. The first arm member 442 is disposed on the threaded shaft 492 axially between the adjustment knob 496 and the first friction gasket 498A.

As generally illustrated in FIGS. 13A and 13B, a user can actuate, turn, and/or twist the adjustment knob 496 to adjust the amount of resistance applied to the adjustable roller 480 by the roller brake 490 to make the adjustable roller 480 easier to rotate (e.g., rotatable with lesser force), harder to rotate (e.g., rotatable with greater force), and/or rotate at higher or lower speeds. Rotating the adjustment knob 496 in the first direction rotates the threaded shaft 492 and moves the threaded shaft 492 and the first friction gasket 498A axially toward the second arm 440′ (e.g., due to the engagement of the external threads of the threaded shaft 492 with the internal threads in the brake recess 448), which causes the first friction gasket 498A to be pressed against the end of the adjustable roller 480 with additional and/or greater force and the second friction gasket 498B to be pressed between the adjustable roller 480 and the second arm 440′ with additional and/or greater force. The increased force being applied to the friction gaskets 498A, 498B results in greater frictional forces and, thus, increases the amount of resistance applied to the adjustable roller 480 by the roller brake 490 making the adjustable roller 480 harder to rotate and/or rotate at lower speeds. Rotating the adjustment knob 496 in the second direction rotates the threaded shaft 492 and moves the first friction gasket 498A axially away from the second arm 440′, which causes the first friction gasket 498A to be pressed against the end of the adjustable roller 480 with less force and the second friction gasket 498B to be pressed between the adjustable roller 480 and the second arm 440′ with less force. The reduced force being applied to the friction gaskets 498A, 498B results in lesser/lower frictional forces and, thus, decreases the amount of resistance applied to the adjustable roller 480 by the roller brake 490 making the adjustable roller 480 easier to rotate and/or rotate at higher speeds.

As generally illustrated in FIGS. 6 and 9, the arms 440, 440′ and/or the arm members 442, 442′ each have an angled Z-shape and/or includes an angled step-down portion such that the second ends of the arms 440, 440′ and/or the rollers 480, 486 connected thereto are vertically offset from the first ends of the arms 440, 440′, the brackets 410, 410′, and/or the mounting plates 402, 402′. Generally speaking, due to this vertical offset, a roll of feed material supported by the feed assembly 400 (e.g., disposed on the rollers 480, 486) is generally positioned lower such that an upper end of the feed material roll is more closely aligned with a feed inlet of the heat transfer printer and cutter connected to the support assembly 400 and/or the mounting plates 402, 402′. This, in turn, enables the feed material to be unrolled and drawn into the heat transfer printer and cutter more smoothly, reducing the likelihood of material feeding mishaps and improving output quality.

As generally illustrated in FIGS. 13A and 13B, the overall axial length of the rollers 480, 486, which may be similar to and/or correspond to the axial length of many commercially available rollers 480, 486 and/or feed material rolls, is generally smaller than the distance between the arms 440, 440′. As such, the roller boss 444 and the threaded shaft 492 of the roller brake 490 partially span and shorten the distance between the second ends of the arms 440, 440′, which enables the rollers 480, 486 to extend between and engage both arms 440, 440′ simultaneously. Shortening the distance between the arms 440, 440′ via the roller boss 444 and the threaded shaft 492 avoids one or more disadvantages of alternative design options. For example, the distance between the second ends of the arms 440, 440′ can alternatively be shortened by bending and/or flaring the second ends of the arms 440, 440′ toward one another. Bending and/or flaring the second ends of the arms 440, 440′ may, however, reduce the structural integrity and/or strength of the arms 440, 440′, reduce load carrying capacity of the feed assembly 400, increase the production cost of the arms 440, 440′, and/or make storing and/or packaging of the arms 440, 440′ more difficult and/or complex. At least some of these potential disadvantages are avoided and/or mitigated by shortening the distance between the arms 440, 440′ via the roller boss 444 and the threaded shaft 492.

FIGS. 14A-14H illustrate an exemplary method of assembling the feed assembly 400 and/or connecting the feed assembly 400 to the support assembly 300. The method generally includes connecting the first mounting plate 402 and the second mounting plate 402′ to the support assembly, connecting the first arm 440 to the first bracket 410 as generally shown in FIGS. 14A-14F, connecting the second arm 440′ to the second bracket 410′, connecting the roller brake 490 to the first arm 440 as generally shown in FIG. 14H, and connecting the rollers 480, 486 to the arms 440, 440′ as generally shown in FIG. 14H. Connecting the second arm 440′ to the second bracket 410′ involves substantially the same steps as connecting the first arm 440 to the first bracket 410 and, therefore, is not described or depicted in detail. It should be noted that that the first arm 440 may be connected to the first bracket 410 and/or the support assembly 300 before or after the second arm 440′ is connected to the second bracket 410′ and/or the support assembly 300. Additionally, the roller brake 490 may be connected to the first arm 440 before or after the first arm 440 has been connected to the first bracket 410 and/or the support assembly 300. While the support assembly 300 is not depicted in FIGS. 14A-14G to provide a clean, unobstructed illustration of the components of the feed assembly 400 during assembly, it should be understood that the mounting plates 402, 402′ depicted in FIGS. 14A-14G are connected to the support assembly 300 (e.g., the support members thereof) via mounting screws as generally shown in FIGS. 9-10B, and 14H.

As generally illustrated in FIG. 14A, connecting the first arm 440 to the first bracket 410 and/or the support assembly 300 includes slidably and pivotably connecting the first arm 440 to the first bracket 410. Slidably and pivotably connecting the first arm 440 to the first bracket 410 includes aligning the slot pin 450 of the first arm 440 with the wide end 416B of the slot 416 of the first bracket 410. As generally shown with the movement arrows in FIG. 14A, the slot pin 450 is then adjusted and/or inserted into the slot 416 (e.g., in the axial direction of the slot pin 450) at the wide end 416B of the slot 416 via moving and/or adjusting the first arm 440 toward the first bracket 410 from the aligned position shown in FIG. 14A to the inserted position shown in FIGS. 14B and 14C. As generally illustrated with the movement arrows in FIG. 14C, slidably and pivotably connecting the first arm 440 to the first bracket 410 further includes adjusting, moving, and/or sliding the slot pin 450 within the slot 416 from wide end 416B of the slot 416 (e.g., the position shown in FIG. 14C) to the narrow end 416A of the slot 416 (e.g., the position shown in FIG. 14D) via adjusting and/or moving the first arm 440 relative to the first bracket 410, the first mounting plate 402, and/or the support assembly 300 in a direction extending from the wide end 416B toward the narrow end 416A.

As generally illustrated with the movement arrows in FIG. 14D, connecting the first arm 440 to the first bracket 410 and/or the support assembly 300 further includes establishing a snap-fit connection between the first arm 440 and the first bracket 410 via adjusting and/or moving the snap-fit pin 452 into the aperture 424 of the first bracket 410 and into engagement with the first retention ring 502. The snap-fit pin 452 is adjusted and/or moved into the aperture 424 of the first bracket 410 and into engagement with the first retention ring 502 via adjusting, moving, and/or pivoting the first arm 440 about the slot pin 450 relative to the first bracket 410 from the position shown in FIG. 14D to the position shown in FIGS. 14E and 14F. Adjusting, moving, and/or pivoting the first arm 440 about the slot pin 450 moves and/or adjusts the slot pin 450 of the first arm 440 in a circumferential direction about the slot pin 450 toward the first bracket 410 and into the aperture 424 of the first bracket 410. Engaging the snap-fit pin 452 with the first retention ring 502 includes adjusting and/or inserting the slot pin 450 into the interior space 506 of the first retention ring 502 through the ring opening 508, during which the slot pin 450 pushes and/or presses the ring legs 512A, 512B away from one another causing them to flex and/or elastically deform into the compensation regions 418A, 418B of the ring depression 418.

As generally illustrated with the movement arrows in FIG. 14F, connecting the first arm 440 to the first bracket 410 and/or the support assembly 300 further includes adjusting and/or moving the stop flange 478 of the safety stopper 470 into the stopper notches 426, 458 via adjusting, pivoting, and/or rotating the safety stopper 470 about the stopper pin 454 (e.g., via pressing and/or pushing the actuation flange 476) from the unlocked position shown in FIGS. 14E and 14F to the locked position shown in FIGS. 14G and 14H.

As generally illustrated with the movement arrows in FIG. 14H, the method includes adjustably connecting the roller brake 490 to the first arm 440 and rotatably connecting the rollers 480, 486 to the arms 440, 440′ as generally shown in FIG. 9. Connecting the roller brake 490 to the first arm 440 includes screwing the threaded shaft 492 into the brake recess 448 (e.g., via engaging the external and internal threads thereof) and subsequently connecting the adjustment knob 496 to the threaded shaft 492 (e.g., via screwing the adjustment knob 496 onto the external threads of the threaded shaft 492). Rotatably connecting the adjustable roller 480 to the arms 440, 440′ includes actuating and/or adjusting the retractable pins 482A, 482B to the retracted position, engaging and/or inserting the first retractable pin 482A in the shaft cavity 494 of the roller brake 490, which rotatably connects the adjustable roller 480 to the first arm 440 via the roller brake 490, and engaging and/or inserting the second retractable pin 482B in the adjustable roller recess 462 of the second arm 440′. Rotatably connecting the passive roller 486 to the arms 440, 440′ includes actuating and/or adjusting the retractable pins 488A, 488B to the retracted position, engaging and/or inserting the first retractable pin 488A in the roller boss 444 and/or the roller cavity 446 of the first arm 440, and engaging and/or inserting the second retractable pin 488B in the passive roller recess 464 of the second arm 440′.

The exemplary illustrations are not limited to the previously described examples. Rather, a plurality of variants and modifications are possible, which also make use of the ideas of the exemplary illustrations and therefore fall within the protective scope. Accordingly, it is to be understood that the above description is intended to be illustrative and not restrictive.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

1. A feed assembly for supporting feed material of a heat transfer printer and cutter and connectable to a support assembly of the heat transfer printer and cutter, comprising:
a first arm;
a second arm;
an adjustable roller extending between and rotatably connected to the first arm and the second arm;
a passive roller extending between and rotatably connected to the first arm and the second arm; and
a roller brake via which adjustable resistance is appliable to the adjustable roller, the roller brake adjustably connected to the first arm and rotatably connected to the adjustable roller.

2. The feed assembly of claim 1, wherein:
the first arm includes a brake recess; and
the roller brake is adjustably connected to the first arm and disposed in the brake recess.

3. The feed assembly of claim 1, wherein the roller brake includes:
a threaded shaft disposed in and extending through the brake recess of the first arm;
an adjustment knob connected to a first end of the threaded shaft, the adjustment knob actuatable via a user to adjust an amount of resistance applied to the adjustable roller by the roller brake; and
a friction gasket connected to an opposite, second end of the threaded shaft, the friction gasket pressable against the adjustable roller to apply force to facilitate friction generation.

4. The feed assembly of claim 1, wherein the adjustable roller and the passive roller each include a plurality of retractable pins engaging the first arm and the second arm and rotatably and releasably connecting the adjustable roller and the passive roller to the first arm and to the second arm.

5. The feed assembly of claim 1, wherein:
the first arm includes a roller cavity and a brake recess;
the second arm includes an adjustable roller recess and a passive roller recess;
the roller brake is adjustably connected to the first arm and disposed in the brake recess;
the roller brake defines a shaft cavity;
the plurality of retractable pins of the adjustable roller includes (i) a first retractable pin received in the roller cavity of the first arm and (ii) a second retractable pin received in the adjustable roller recess of the second arm; and
the plurality of retractable pins of the passive roller includes (i) a first retractable pin received in the shaft cavity of the roller brake and (ii) a second retractable pin received in the passive roller recess of the second arm.

6. The feed assembly of claim 5, wherein:
the first arm further includes a roller boss projecting toward the second arm; and
the roller boss defines the roller cavity.

7. The feed assembly of claim 1, further comprising:
a first bracket releasably and adjustably connected to the first arm; and
a second bracket releasably and adjustably connected to the second arm;
wherein the first arm is connectable to said support assembly via the first bracket; and
wherein the second arm is connectable to said support assembly via the second bracket.

8. The feed assembly of claim 7, wherein:
the first bracket includes a slot; and
the first arm includes a slot pin adjustably received in the slot and rotatably connecting the first arm to the first bracket.

9. The feed assembly of claim 8, wherein the slot includes:
a narrow end at which the slot pin is prevented from being inserted into and removed from the slot of the first bracket; and
a wide end at which the slot pin is insertable into and removable from the slot of the first bracket.

10. The feed assembly of claim 7, wherein:
the first bracket further includes an aperture and a retention ring; and
the first arm includes a snap-fit pin removably received in the aperture and releasably engaged with the retention ring connecting the first arm to the first bracket via a snap-fit connection.

11. The feed assembly of claim 10, wherein the first bracket further includes:
a ring depression in which the retention ring is disposed; and
a bracket cover at least partially closing the ring depression and securing the retention ring within the ring depression.

12. The feed assembly of claim 11, wherein the first bracket further includes a plurality of retention protrusions projecting into the ring depression and engaging the retention ring such that an orientation of the retention ring within the ring depression is maintained.

13. The feed assembly of claim 11, wherein:
the aperture extends into the ring depression from a lower end of the first bracket; and
the retention ring includes a plurality of retention projections that project into the aperture and contact the snap-fit pin of the first arm.

14. The feed assembly of claim 7, wherein the first arm includes:
a stopper pin; and
a safety stopper disposed on and rotatably connected to the stopper pin, the stopper pin configured to selectively engage the first bracket to restrict movement of the first arm relative to the first bracket.

15. The feed assembly of claim 14, wherein the safety stopper includes:
a main body;
an actuation flange projecting from the main body toward the first bracket, the actuation flange facilitating user actuation of the safety stopper; and
a stop flange projecting from the main body away from the first bracket, the stop flange selectively engageable with the first bracket to restrict movement of the first arm relative to the first bracket.

16. The feed assembly of claim 14, wherein:
the first bracket further includes a stopper notch;
the safety stopper is rotatable about the stopper pin to a locked position and to an unlocked position;
when the safety stopper is in the locked position, the stop flange is disposed in the stopper notch of the first bracket; and
when the safety stopper is in the unlocked position, the stop flange is disposed outside of the stopper notch of the first bracket.

17. The feed assembly of claim 16, wherein:
the first arm further includes a stopper notch;
when the safety stopper is in the locked position, the stop flange is disposed in the stopper notch of the first bracket and the stopper notch of the first arm simultaneously; and
when the safety stopper is in the unlocked position, the stop flange is disposed outside of the stopper notch of the first bracket and the stopper notch of the first arm.

18. The feed assembly of claim 14, wherein:
the stopper pin includes a ring groove;
the first arm further includes a retention ring connected to the stopper pin; and
the retention ring is disposed at least partially in the ring groove and secures the safety stopper to the stopper pin.

19. A method of connecting a feed assembly for supporting feed material of a heat transfer printer and cutter to a support assembly of the heat transfer printer and cutter, comprising:
providing a first arm, a second arm, a first bracket, a second bracket, an adjustable roller, a passive roller, and a roller brake;
slidably and pivotably connecting the first arm and the first bracket;
establishing a snap-fit connection between the first arm and the first bracket via pivoting the first arm relative to the first bracket;
slidably and pivotably connecting the second arm and the second bracket;
establishing a snap-fit connection between the second arm and the second bracket via pivoting the second arm relative to the second bracket;
adjustably connecting the roller brake to the first arm;
rotatably connecting the adjustable roller to the first arm and to the second arm; and
rotatably connecting the passive roller to the first arm and to the second arm.

20. The method of claim 19, wherein:
slidably and pivotably connecting the first arm and the first bracket includes:
inserting a slot pin of the first arm into a slot of the first bracket via adjusting the first arm toward the first bracket; and
moving the slot pin within the slot from a wide end of the slot to a narrow end of the slot; and
establishing the snap-fit connection between the first arm and the first bracket includes adjusting a snap-fit pin of the first arm into an aperture of the first bracket and into engagement with a retention ring of the first bracket via pivoting the first arm about the slot pin while the slot pin is disposed at the narrow end of the slot.
